(19) United States
(12) Patent Application Publication
(10) Pub. No.: US 2013/0018618 A1
(43) Pub. Date: Jan. 17, 2013

(54) METHOD AND SYSTEM FOR AUTOMATED QUALITY CONTROL PLATFORM

(71) Applicants: Dennis Eshima, Phoenix, AZ (US); Mehmet Husnu, Phoenix, AZ (US); Jim Stone, Alpharetta, GA (US)

(72) Inventors: Dennis Eshima, Phoenix, AZ (US); Mehmet Husnu, Phoenix, AZ (US); Jim Stone, Alpharetta, GA (US)

(73) Assignee: CARDINAL HEALTH 414, LLC, Dublin, OH (US)

(21) Appl. No.: 13/550,030

(22) Filed: Jul. 16, 2012

Related U.S. Application Data
(60) Provisional application No. 61/508,353, filed on Jul. 15, 2011.
(60) Provisional application No. 61/553,029, filed on Oct. 28, 2011.

(51) Int. Cl. G06F 19/00

(52) U.S. Cl. 702/83

(57) ABSTRACT

A method and system for performing automated quality control analysis of a plurality of radiopharmaceuticals are provided. The method includes uniquely identifying each of the plurality of radiopharmaceuticals, and identifying and implementing a tailored quality control program for each of the radiopharmaceuticals. The method further includes automatically performing a plurality of selected quality control tests for each of the radiopharmaceuticals based on the tailored quality control program, and collecting information produced by the plurality of selected quality control tests.

### RELATED APPLICATIONS

This application claims priority from U.S. Provisional Application No. 61/508,294 entitled “SYSTEMS, METHODS, AND DEVICES FOR PRODUCING, MANUFACTURING, AND CONTROL OF RADIOPHARMACEUTICALS-FULL” filed on Jul. 15, 2011, U.S. Provisional Application No. 61/508,353 entitled “METHOD AND SYSTEM FOR AUTOMATED QUALITY CONTROL PLATFORM” filed on Jul. 15, 2011, and U.S. Provisional Application No. 61/553,029 entitled “METHOD AND SYSTEM FOR AUTOMATED QUALITY CONTROL PLATFORM-PART 2” filed on Oct. 28, 2011. The entirety of each of the preceding applications is incorporated by reference herein.

### BACKGROUND OF THE INVENTION

1. Field of Invention

Aspects of the present invention relate to the field of automated production of radiopharmaceuticals, and in particular to systems, methods, and devices including quality control (QC), for safe, secure, and flexible production of one or more output streams of radiopharmaceuticals, and delivering the output streams for individual bulk vial fill and dose level distribution, wherein QC may be provided contemporaneously with or subsequent to radiopharmaceutical dose production.

2. Background

It is known in the related art to provide shielded containment systems for use in combining cyclotron produced radionuclides with non-radionuclide components to produce radiopharmaceuticals.

There are many drawbacks of these related art systems, including the following: 1) cyclotron production is often limited and does not allow rapid production and distribution of short half-life radionuclides that are often needed; 2) typically only one radiopharmaceutical may be produced in a production run, after which various radionuclide raw material components and physical system components must be replaced or decontaminated, which can greatly delay the production process and/or make the process much less efficient; 3) many aspects of the production of radiopharmaceuticals in such related art systems are not automated and/or may require time-consuming and/or difficult to control hand production steps; 4) the expected radioactivity and/or quantities of the raw radionuclide and/or the produced radiopharmaceutical material may be inaccurate and/or difficult to determine precisely; 5) the necessary QC to be performed on the output radiopharmaceutical product may be time-consuming, inaccurate, and/or require high levels of worker input/skill, further hampering production and/or timely delivery of the produced radiopharmaceuticals; 6) some aspects of the control, monitoring, and/or other production aspects may lack and/or hamper development of appropriate protections, such as shielding to minimize damage and maximize service life for equipment; 7) production/dispensing may be imprecise and/or inefficient and/or may require inefficient or time consuming human intervention, as well as inefficient reuse of components and/or decontamination requirements; 8) control system software and hardware for overall operation and/or subsystem operation may be insufficient or not implementable; and 9) such existing systems may not provide or support use of remote and/or centralized data collection, control, operation and maintenance.

Conventional manual QC operations for Positron Emission Tomography (PET) tracers are known to be labor intensive and time consuming. PET is a molecular imaging technology that is increasingly used for detection of disease. PET imaging systems can create images based on the distribution of positron-emitting isotopes in the body of a patient. The isotopes are typically administered to a patient by injection of probe molecules, which comprise a positron-emitting isotope, e.g., carbon-11, nitrogen-13, oxygen-15, or fluorine-18, attached to a molecule that is readily metabolized or localized in the body or that chemically binds to receptor sites within the body. The short half-lives of the positron emitters require that synthesis, purification and analysis, such as QC of the probes are completed rapidly. In one aspect, some results of the manual QC tests rely on the interpretation of experienced operators. The manual QC operation may pose hazardous exposure to the operators. Also many aspects of manual QC rely on non-quantitative data and the analysts' opinions.

### SUMMARY OF THE INVENTION

The present invention is directed towards a method for performing automated quality control analysis of a plurality of radiopharmaceuticals. The method includes uniquely identifying each of the plurality of radiopharmaceuticals, and identifying and implementing a tailored quality control program for each of the radiopharmaceuticals. The method further includes automatically performing a plurality of selected quality control tests for each of the radiopharmaceuticals based on the tailored quality control program, and collecting information produced by the plurality of selected quality control tests.

The present invention also presents a system for performing automated quality control analysis of a plurality of radiopharmaceuticals. The system includes at least one processor configured to uniquely identify each of the plurality of radiopharmaceuticals. The at least one processor is also configured to identify and implement a tailored quality control program for each of the radiopharmaceuticals. The at least one processor is further configured to automatically perform a plurality of selected quality control tests for each of the radiopharmaceuticals based on the tailored quality control program. The at least one processor is also configured to collect information produced by the plurality of selected quality control tests.

### BRIEF DESCRIPTION OF THE DRAWINGS

Various exemplary aspects of the systems and methods will be described in detail, with reference to the following figures, wherein:

FIG. 1 is an example communication system in accordance with aspects of the present invention;

FIG. 2 is an automated QC system and apparatus in accordance with aspects of the present invention;

FIG. 3 is a flowchart of example operations of an example QC process in accordance with aspects of the present invention;

FIGS. 4-21 are various graphical user interface (GUI) screens of an example QC system in accordance with aspects of the present invention;

FIG. 22 is an example implementation of a QC system in accordance with aspects of the present invention;

FIG. 23 illustrates an example robotic sample manipulating system in accordance with aspects of the present invention;

FIG. 24 shows multiple robots including 3 axis units in accordance with aspects of the present invention;

FIG. 25 is a cutaway view illustrating the modular nature of the full QC system in accordance with aspects of the present invention;

FIG. 26 is an example system diagram of various hardware components and other features, for use in accordance with aspects of the present invention;

FIG. 27 is a block diagram of various example system components, for use in accordance with aspects of the present invention;

FIGS. 28A-C show an example overall control process of an automated QC system and apparatus in accordance with aspects of the present invention;

FIG. 29 is an example analytical control process of an automated QC system and apparatus in accordance with aspects of the present invention;

FIG. 30 is an example communication flow chart of an automated QC system and apparatus in accordance with aspects of the present invention; and

FIG. 31 illustrates a flow diagram for performing automated QC analysis of a plurality of radiopharmaceuticals in accordance with aspects of the present invention.

### DETAILED DESCRIPTION OF PREFERRED ASPECTS

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

There are disclosed, as various aspects of the present invention, methods and apparatus for performing an automated QC testing process for determining and obtaining a plurality of control parameters of a vial. For example, aspects of the present invention may relate to a plurality of tests. As used herein, the term “determining,” or “evaluating” encompasses a wide variety of actions. For example, “determining,” and “evaluating” may include calculating, computing, processing, deriving, investigating, looking up (e.g., looking up in a table, a database or another data structure), ascertaining and the like. Also, “determining,” and “evaluating” may include receiving (e.g., receiving information), accessing (e.g., accessing data in a data repository) and the like. Also, “determining” may include resolving, selecting, choosing, establishing and the like.

As used in this invention, the terms “element,” “module,” “component,” and “system” may refer to a computer-related entity, either hardware, a combination of hardware and software, software, or software in execution. For example, a module may be, but is not limited to being, a machine-executable process running on a processor, a processor, an object, a thread of execution, a machine-executable program, and/or a computer. By way of illustration, both an invention running on a server and the server can be a module or a component. One or more modules or components may reside within a process and/or thread of execution. In some implementations, a module may be localized on one computer and/or distributed between two or more computers.

As disclosed herein, the term “radionuclides” refers to isotopes exhibiting radioactive decay (e.g., emitting positrons). Such isotopes are also referred to in the art as radioisotopes or radioactive isotopes. Radioactive isotopes or the corresponding ions, such as the fluoride ion, are named herein using various commonly used combinations of the name or symbol of the element and its mass number and are used interchangeably (e.g., 18F, [18F], F-18, [F-18], fluorine-18). Exemplary radioactive isotopes include 124I, 18F, 11C, 13N and 15O, which have half-lives of 4.2 days, 110 minutes, 20 minutes, 10 minutes, and 2 minutes, respectively.

“Kryptofix” or “K222” generally refers to a trade name for commercially available cryptands. Cryptands are a family of synthetic bi- and polycyclic multi-dentate ligands for a variety of cations. These molecules are three dimensional analogues of crown ethers but are more selective and complex. The most common and most important cryptand is N[CH₂CH₂OCH₂CH₂OCH₂CH₂]₃N. This compound is termed [2.2.2]cryptand where the numbers indicate the number of ether oxygen atoms (and hence binding sites) in each of the three bridges between the amine nitrogen “caps.” All-amine cryptands exhibit particularly high affinity for alkali metal cations, which has allowed the isolation of salts of K⁻.

Limulus Amebocyte Lysate (LAL) endotoxins test may be used to measure, for example, a concentration that is a component of gram-negative bacterial cell walls. Endotoxins are, for example, toxins associated with certain bacteria.

The term “column” means a device that may be used to separate, purify or concentrate chemical compounds. Such columns include, but are not limited to, various types of HPLC columns and Gas Chromatography (GC) columns. For example, HPLC is liquid phase separation/detection instrument. GC is gas phase separation/detection instrument. Both HPLC and GC use columns. HPLC usually uses a packed column whereas the GC typically uses a coated capillary column.

The term “sample” generally refers to a homogeneous or a heterogeneous fluid. Solution is an example of a homogeneous fluid. Heterogeneous fluid such as, for example, a suspension or slurry, contains solid particles, for example, insoluble reagents or products, or beads (reagents on solid support). Heterogeneous fluids also include emulsions or colloids.

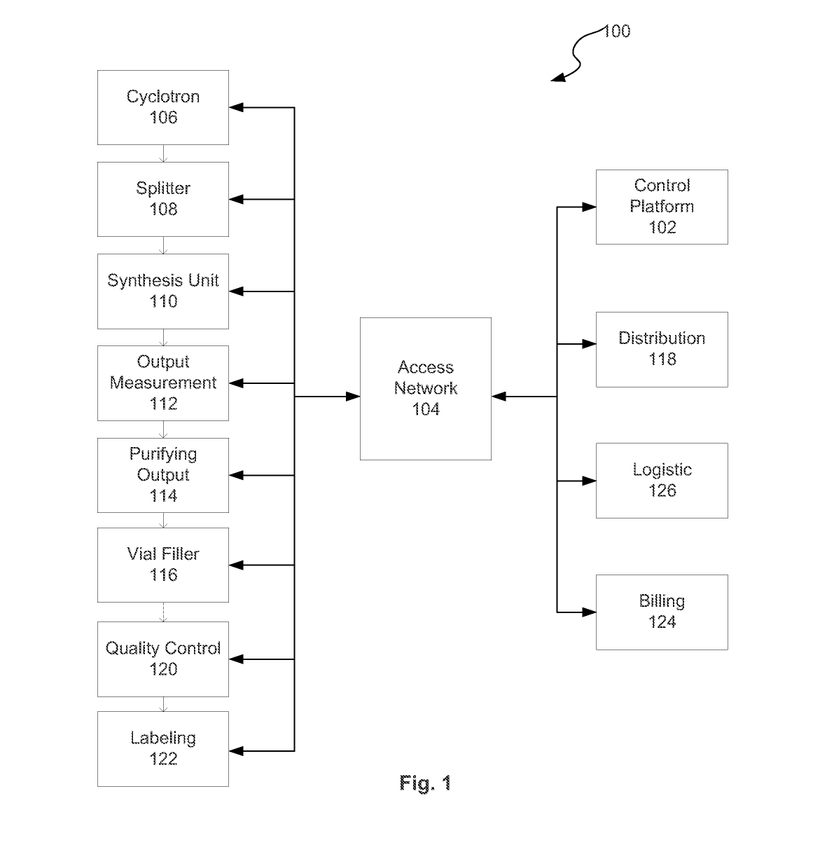

Referring now to FIG. 1, therein illustrated is an example communication system 100 with one or more control platforms 102 communicating via an access network 104 with one or more systems, such as a cyclotron system 106, splitter system 108, synthesis units system 110, output measurement system 112, purifying output system 114, vial filler system 116, distribution system 118, QC system 120, labeling system 122, billing system 124, and/or logistic system 126, in accordance with aspects of the present invention.

It should be appreciated that the one or more systems 106-126, may comprise wired, wireless, and/or fiber optically communicating devices and/or other computing devices. Wireless devices, for example, may include any suitable mobile, portable computing or communications device, such as a cellular device, that may connect to an access network 104. For example, wireless devices may include a cellular telephone, a navigation system, a global positioning system (GPS), a computing device, a camera, a personal digital assistant (PDA), or other handheld device having wireless connection capability, among other devices. It should also be appreciated that control platform 102 may comprise a server and/or computing devices that may include, for example, any suitable mobile or fixed computing device connected to a network.

Control platform 102 may use the input received from one or more systems, such as cyclotron system 106, splitter system 108, synthesis unit system 110, output measurement system 112, purifying output system 114, vial filler system 116, distribution system 118, QC system 120, labeling system 122, billing system 124, and/or logistic system 126 to create an environment for controlling and/or managing the production and distribution of radiopharmaceuticals.

Control platform 102 may further use the input received from one or more systems 106-120 for performing QC measurements during the production of radiopharmaceuticals. QC tests may include, but are not limited to, checking and/or testing the status of each of the systems 106-126, checking the environment surrounding systems 106-126, testing outputs produced by each of the systems 106- 126, and/or performing testing on samples of the radiopharmaceuticals produced by system 100, among other QC measures. In an aspect, a regulatory agency, such as the Food and Drug Administration (FDA) may regulate the production of radiopharmaceuticals and require that a quality threshold be met during production. QC system 120 may be used, for example, to generate one or more quality reports relating to the quality of the radiopharmaceuticals produced by system 100. Quality reports may include, but are not limited to: analytical tests performed on the product; total yield of the product; failure reports for the product; failure reports for the one or more systems or sub-systems used to manufacture the product; and/or operator error reports, among other quality reports. QC system 120 may interface with each individual system when performing the QC measures.

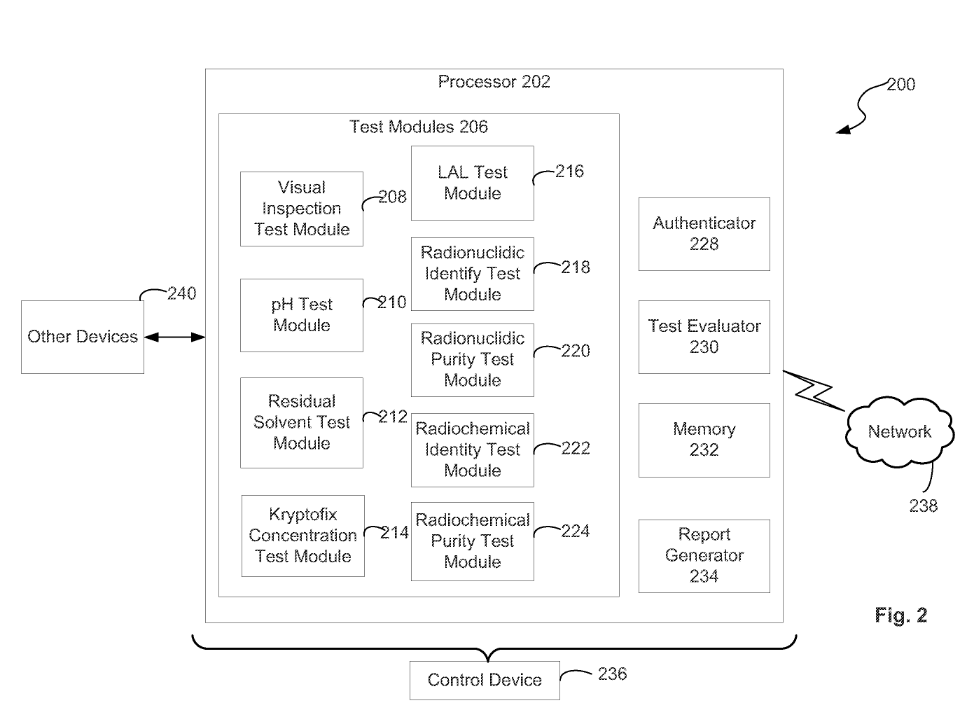

Referring to FIG. 2, an automated QC system and apparatus 200 according to aspects of the present invention may be used, for example, for radiosynthesized tracers, covering a plurality of tests, which assess, for example, particle and color content (clarity, pH value, residual solvent test, residual catalyst (Kryptofix) concentration, bacterial endotoxin concentration, radionuclidic identify, radionuclidic purity, radiochemical identity, radiochemical purity, tests.

The automated QC system and apparatus 200 may advantageously record documentation and archive the materials used in the QC process and report various testing results in compliance with the current Good Manufacturing Practice (cGMP) regulations and title 21 C.F.R. Part 11 of the Code of Federal Regulations regarding the Food and Drug Administration (FDA) guidelines on electronic records and electronic signatures in the United States. Aspects of the present invention relate to self-calibration of some or all of the tests with reporting capabilities in real time or near real-time. In one aspect, the present invention may enable simplified and fully automated QC operations by facilitating each and all of the above tests in an efficient manner (e.g., in 30 minutes or less). The test results may be quantitative, and multiple tests may be advantageously performed in parallel. As a result, the test results may be more reliable, and the overall QC process may be more economical and efficient as time and labor for the QC process may be significantly reduced. In addition, the data or operational parameters may be transmitted to another location for verification or interpretation.

FIG. 2 generally shows modules as part of a control device 236. The modules of FIG. 2 may include program codes and algorithms for calculating values based on measured data. A processor unit or module 202 may carry out measurements of various parameters using a plurality of test modules 206, process the obtained parameters using a test evaluator 230, authenticate the user and the test results using an authenticator 228, transmit the data over network 238 to remote users and devices, transmit data to other devices 240 such as periphery devices including displays, and/or printers, store the processed data in a memory 232, and generate 234 a report.

In one aspect, the processor 202 may include an arithmetic logic unit (ALU), which performs arithmetic and logical operations, and a control unit (CU), which extracts instructions from memory and decodes and executes them, utilizing the ALU when necessary. In some other aspects, the processing unit, device, module, or terminal 202 may be one or more computers, or other processing device(s), wireless processing device, personal computer (PC), desktop, notebook, information appliance and the like. The control device 236 with the processor 202 embedded therein, as shown, can be coupled to network 238 via bi-directional communication medium. The network 238 is, for example, any combination of linked computers, or processing devices, adapted to transfer (transmit and/or receive) and process data. The network 238 may include wireless and wired transmission capabilities. The network 238 may be a private Internet Protocol (IP) network, as well as a public IP network, such as the Internet that can utilize World Wide Web (www) browsing functionality. Alternatively, the network 238 may be an Ethernet network, or any two or more operatively coupled processing devices that can share information. An example of a wired network is a network that uses communication busses and MODEMS, or DSL lines, or a local area network (LAN) or a wide area network (WAN) to transmit and receive data between terminals (e.g., the processor 202 and the plurality of test or measurement modules 208-224). An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

Test or measurement modules 206 may include, for example, a visual inspection module utilizing image recognition technology module 208, pH test module 210, residual solvent test module 212, Kryptofix concentration test module 214, LAL (endotoxin) test module 216, radionuclidic identity test module 218, radionuclidic purity test module 220, radiochemical identity test module 222, radiochemical purity test module 224. Each of these modules may be configured by the processor 202 to perform the associated function described herein via, e.g., robotics. Additional test modules may be added such that the automated QC system and apparatus 200 is expandable and flexible.

Memory 232 may be used to store predetermined criteria for various parameters obtained from the plurality of test modules 208-224. Memory module 232 is, for example, an electronic storage medium, or other electronic storage repository that can store data. The memory module 232 may include, for example, RAM, ROM, EEPROM or other memory media, such as an optical disk, optical tape, CD, or a floppy disk, a hard disk, or a removable cartridge, on which digital information is stored in the form of bits.

Test evaluator 230 may automatically make a comparison between each measured value and an associated predetermined quantity to determine whether each measured parameter is satisfactory, i.e., “passes.” Report generator 234 may subsequently generate a report identifying the outcome of each test and whether a sample passed all of the tests.

In some implementations, the measured parameters and testing results of the automated QC system and apparatus 200 can be password controlled/protected (e.g., using radio frequency identifier (RFID) access techniques). Accordingly, an authenticator 228 may be configured to perform authentication for various users/devices requesting to access and retrieve the information stored in the system 200. In one aspect, the authenticator 228 may receive requests for authentication and one or more items of information from various remote users/devices via network 238. In another aspect, the authenticator 228 may include hardware and/or software that require a user to create, e.g., a user account, new membership, etc., with a network system (not shown) on which the processor 202 is hosted. In some example implementations, the authenticator 228 may authenticate a user via using, e.g., keyboard dynamics, a one-time password, a computer fingerprint, one or more out-of-wallet questions, and a voice print, among other authentication mechanisms. Keyboard dynamics generally relates to the unique way (the speed at which the key is typed, the length a user holds down a key, and the duration between keystrokes, among other factors) the user types in a word or phrase, such as a password. A one-time password may be a password that is sent to a user's known email account, mobile telephone, other device, or account that allows an authorized user to retrieve and use the password. A computer fingerprint refers to an item of information stored on the user's computer or generated from the unique characteristics of the user's computer, such as the type of computer, the date, the processor used, the amount of computer memory, and the time, among other factors. An out-of-wallet question refers to a question directed to a specific user, such as “What is your favorite color?” A voice print is the unique characteristics of a person's voice based on the frequency and amplitude, when a user says a predetermined phrase or word. One skilled in the art will recognize that other types of authentication processes or methods are possible and contemplated as being used in the automated QC system and apparatus 200. The authenticator 228 then may compare the user input against associated data stored in the memory 232 to determine whether to grant or deny a specific user the right to access the requested information.

Other devices 240 including image display units or other output devices may be coupled to the control device 236 via bi-directional communication medium, which may be a bus or wired connection or wireless connection. Here, a display unit may be used to display a testing report or output data generated by the processor 202. The display unit may be, for example, a monitor, LCD (liquid crystal display), a plasma screen, a graphical user interface (GUI) or other module adapted to display output data. The control device 236 may also be coupled to a printer to print the output, or a transmission module, such as a Digital Subscriber Line (DSL) line (not shown) or a modem, such as a wireless modem (not shown) for transmitting the output to a second location or another display module. This transmission may also be accomplished using the network 238 with web browsing capability, or other networks including operatively coupled computers, processors, or output devices.

The control device 236 may also include operating system programs (not shown), input/output programs (not shown), and other programs that facilitate the QC operations disclosed herein.

In some implementations, the automated QC system and apparatus 200 may be deployed on a standard platform having an open architecture. For example, it may include an external server (not shown) maintained by a software vendor and an internal network of a customer of the software vendor, coupled to each other via a secured connection, such as a virtual private network (VPN) over a public network (e.g., network 238). The internal network of the customer may include a centralized server coupled with a number of computing machines for carrying out various measurements of a sample, a database, and a console. The computing machines may be physical hardware located in different physical locations, such as servers, workstations, desktop personal computers (PCs), laptops and the like. The computing machines may also be individually hardware modules (e.g., robotics) that reside on a common platform. In some examples, one or more of the computing machines may be coupled to the centralized server via a proxy. The proxy may cache software packages to speed up downloads and offload some of the QC operations from the centralized server. The centralized server may be configured to track and log changes that occurr anywhere in the internal network. Because all of the relevant information from all aspects of the QC process is organized, stored and located centrally, the automated QC system and apparatus 200 facilitates multi-site data collection, reporting and controlling, and advantageously facilitates real-time identification of QC related issues by providing timely notifications when, e.g., any of the testing results are out of specification, in addition machine parameters can be sent remotely to indicate the functional status of the equipment for increased reliability. The automated QC system and apparatus 200 may also advantageously provide an interface with, e.g., Systems, Inventions, Products in data processing (SAP), Health Level 7 (HL7), or other interfaces known in the art, such that the output data from the system 200 can be compatibly integrated with related data systems.

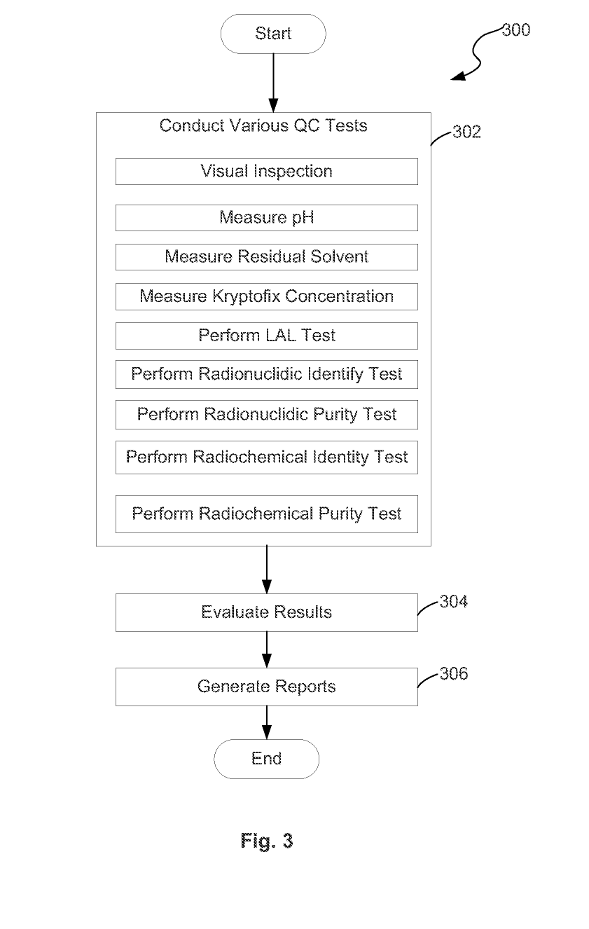

FIG. 3 illustrates a flowchart 300 of a QC method and example operations according to an aspect of the present invention. The sequence and the actual tests can vary depending on the particular PET drug being tested. Flowchart 300 generally includes, for example, a series of processes or program code, such as executable or computer code, that maybe stored on a computer-readable medium or other electronic storage medium, such as a RAM, ROM, EEPROM, CD, DVD, non-volatile memory, removable memory card or non-transitory electronic storage medium. The example operations depicted herein may be executed by robotics.

An automated QC analysis process of an agent, such as a PET tracer, may start from loading a sample into a single injection in, e.g., a syringe or vial or more direct transportation via a tube from a synthesis of dispensing unit for example. In block 302, a plurality of various tests may be carried out to obtain a complete analysis of the sample under study. For example, tests to determine and evaluate particle and color content (visual inspection), pH value, residual solvent, Kryptofix concentration, bacterial endotoxins concentration, radionuclidic identify, radionuclidic purity, radiochemical identity, radiochemical purity. It is understood that each test described above may be performed contemporaneously with the other tests. That is, all of the measurements may not be performed in a sequence, and parallel processing may greatly enhance the speed at which the tests can be performed. In some example implementations, a measurement value for specific activity of the sample may also be determined. In block 304, a comparison may be made between each measured value and an associated predetermined quantity to determine whether each measured parameter is satisfactory, i.e., “passes.” Each measured parameter may be required to pass the associated test for the entire sample to pass. When all of the desired parameters are identified and have been deemed satisfactory, a report may be generated in block 306. This report may provide an explanation of each test performed and the result of each test. In some aspects, in case the sample fails the required QC tests, a report providing the reason for failure may be generated. The reasons for the failed samples may include a particular test the sample failed, improper test conditions occurred, and inadequate sample size, among other reasons. The report may be saved, transmitted, and/or otherwise output on an output device. Finally, when the full QC test has been completed, the system may perform a self-cleaning and calibration cycle automatically, after which it may be ready for the next QC test. More than one compound sequence can be performed contemporaneously.

One of the most important aspects of automation may be the introduction of interfaces between instruments, modules, computers, centralized user-friendly software and hardware for system control and data collecting/processing. One of the main qualities required for interfaces, designed to collect analog signals and digitize them to reflect detector output accurately, may include good sampling rates and high resolution. Other important aspects of automation may directly be related to the evolution of individual instruments, and the possibility of coupling/connecting them to facilitate data transfer and exchange.

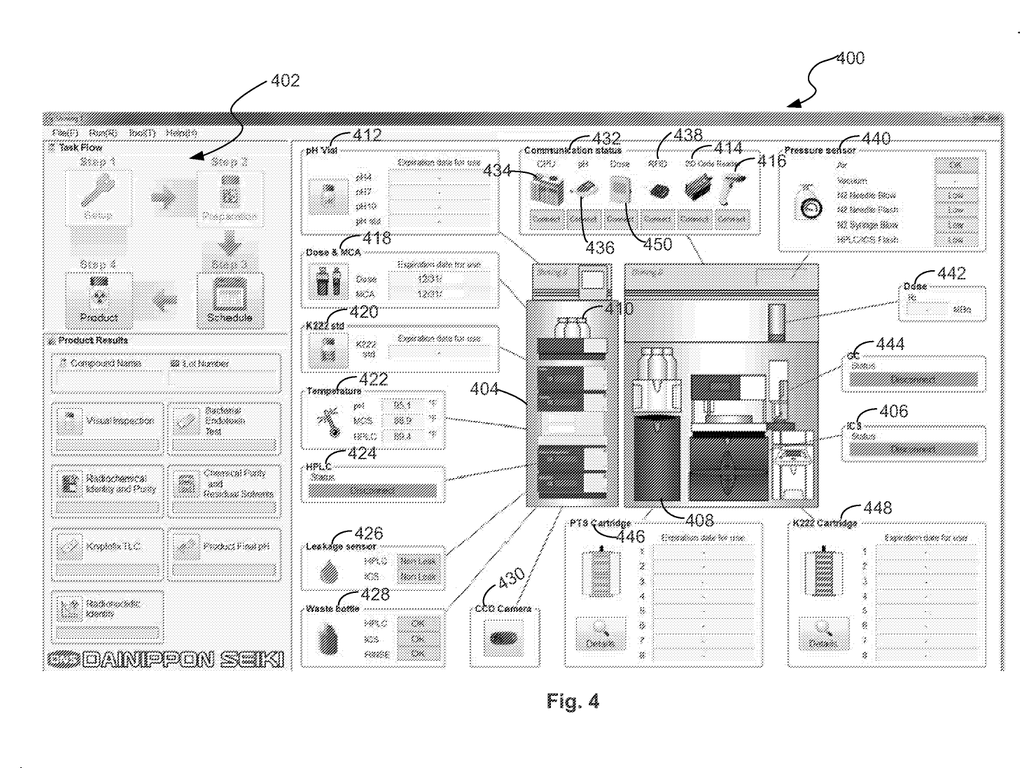

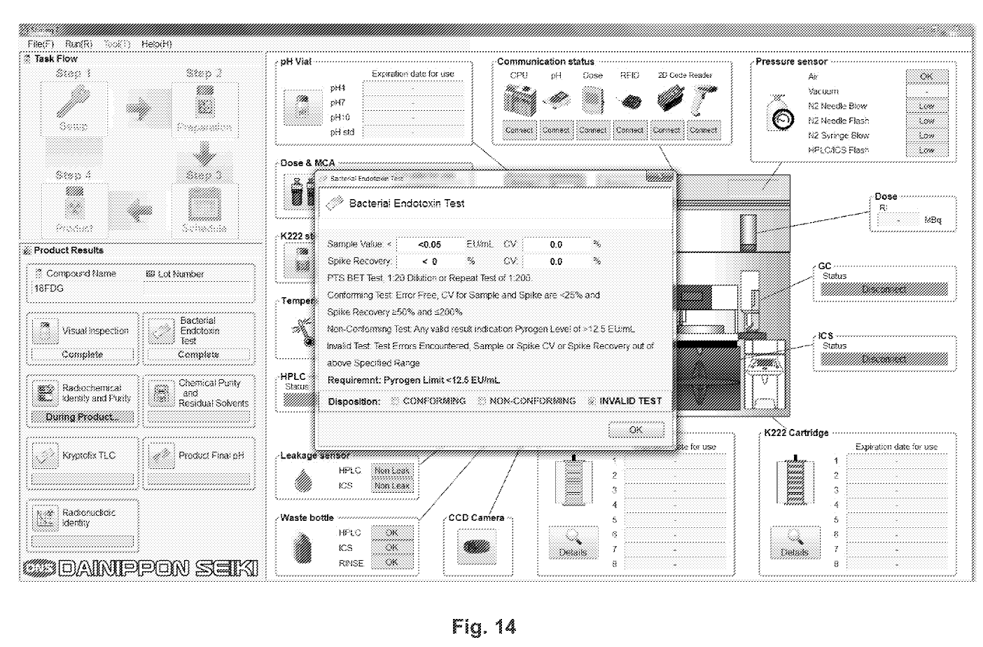

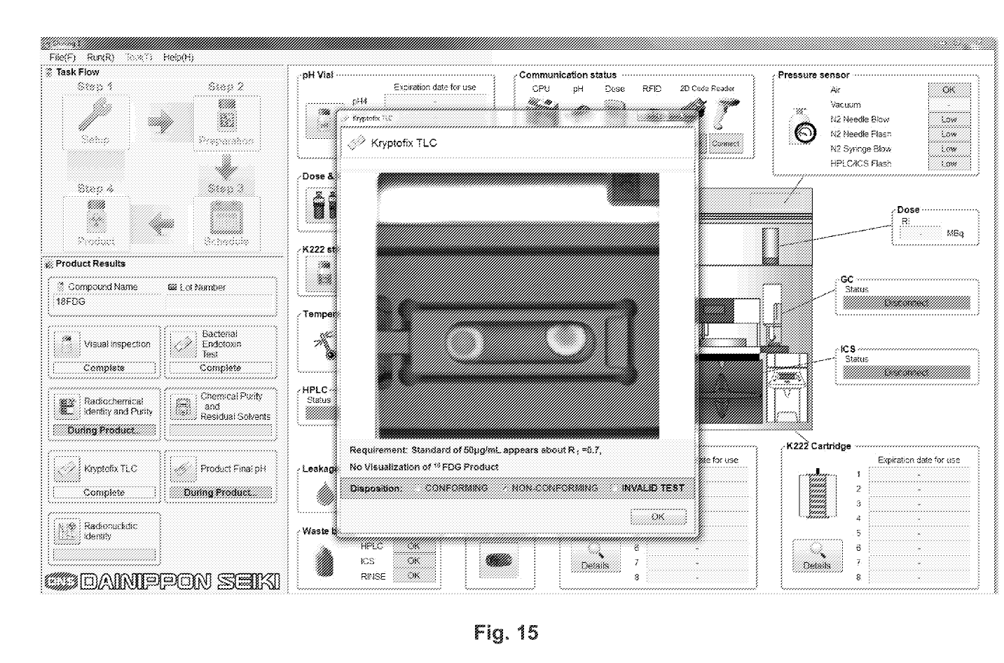

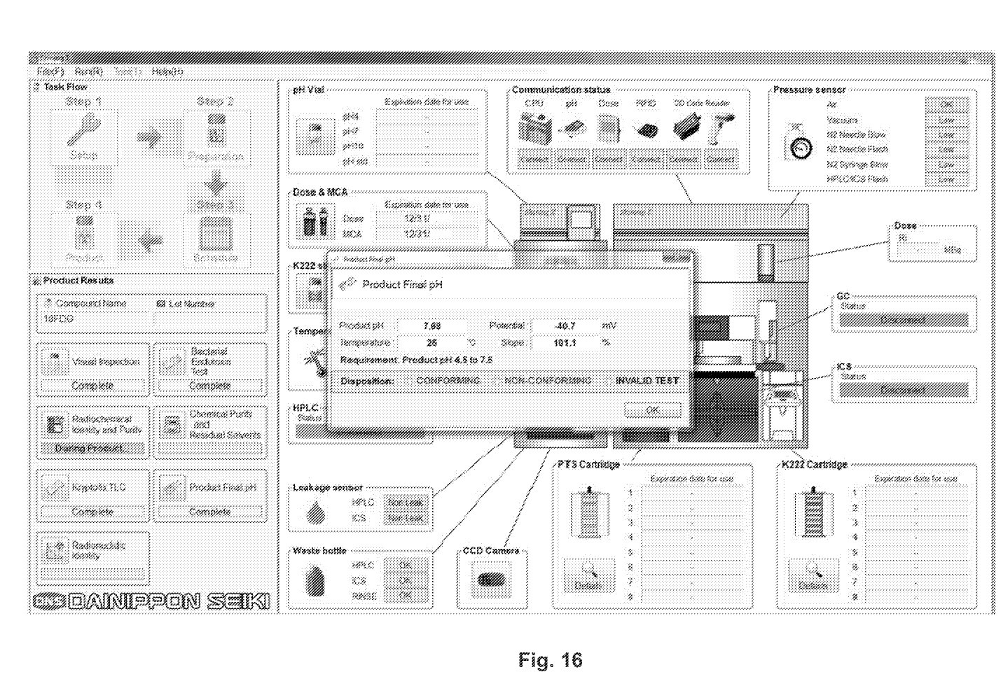

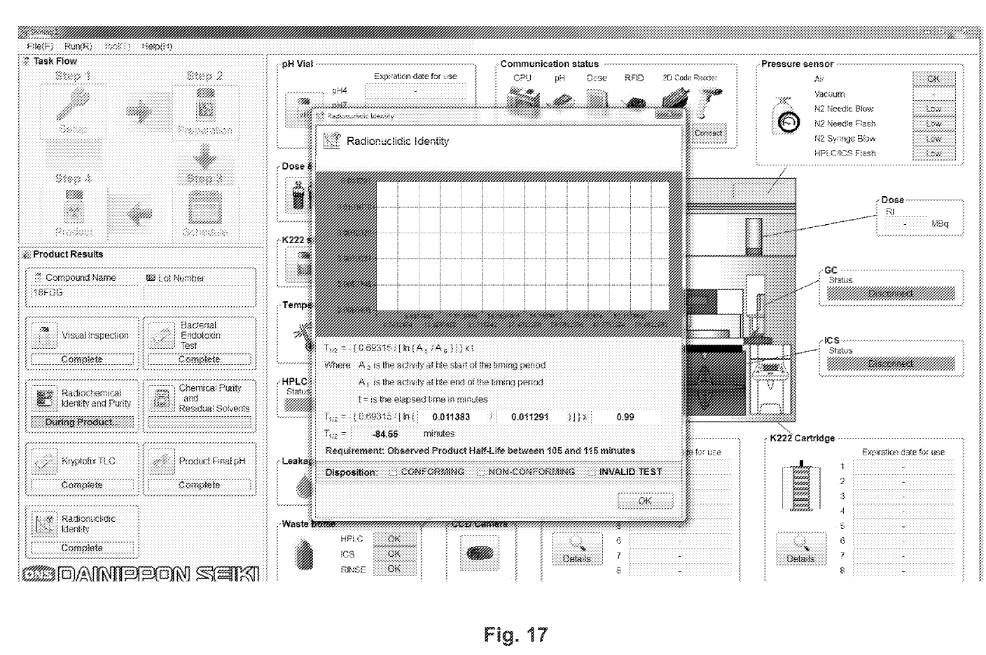

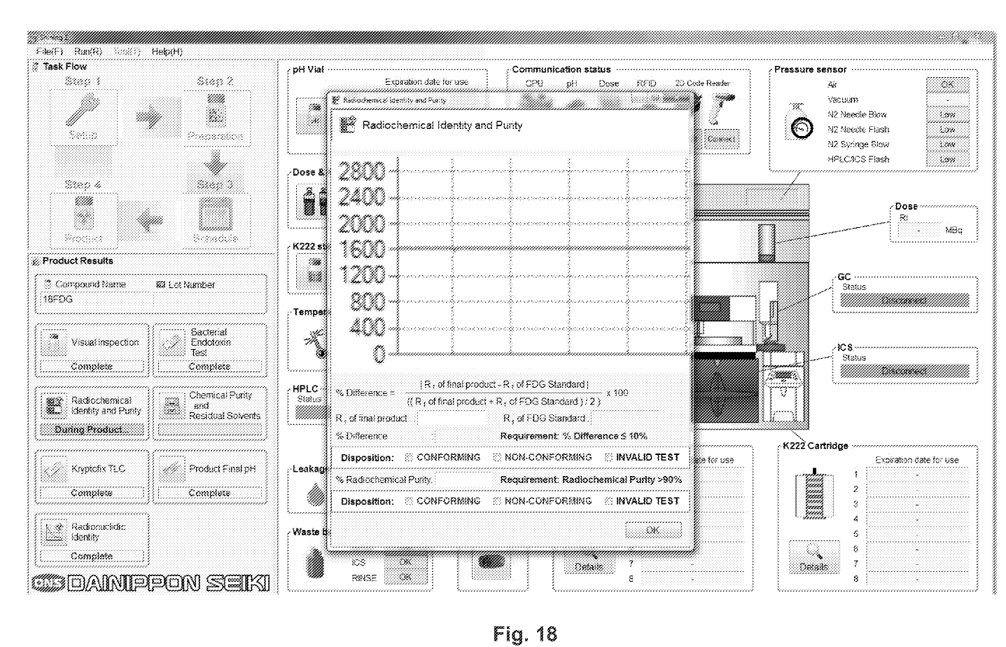

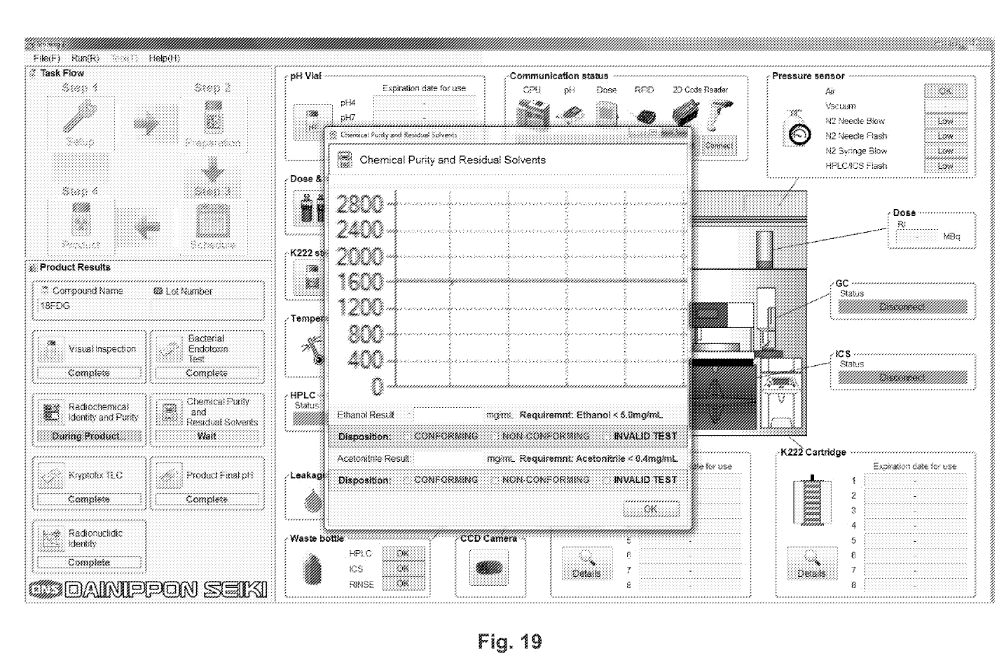

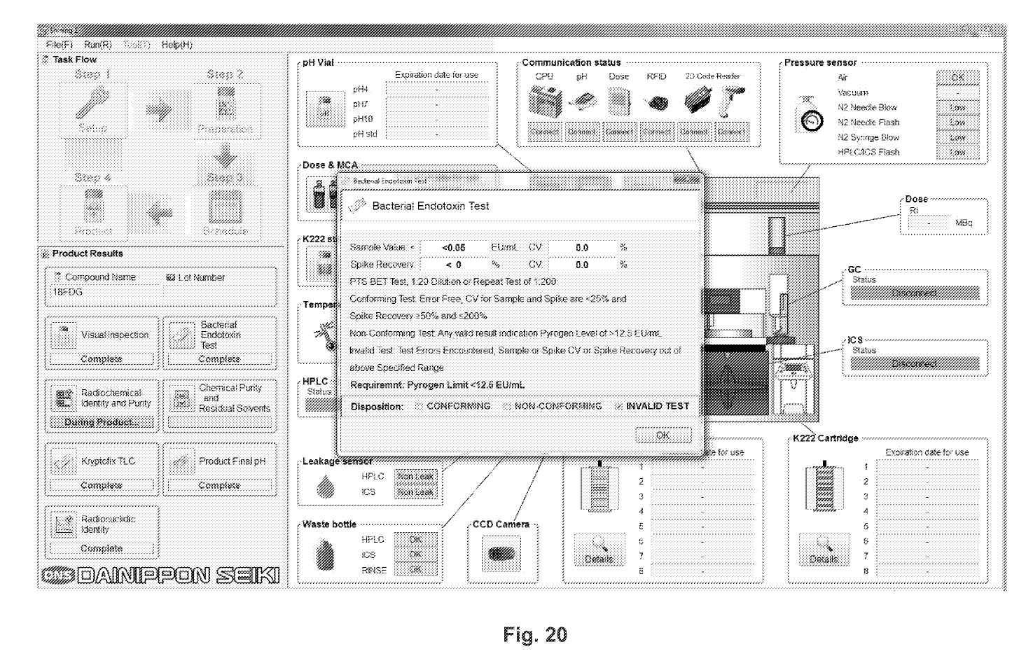

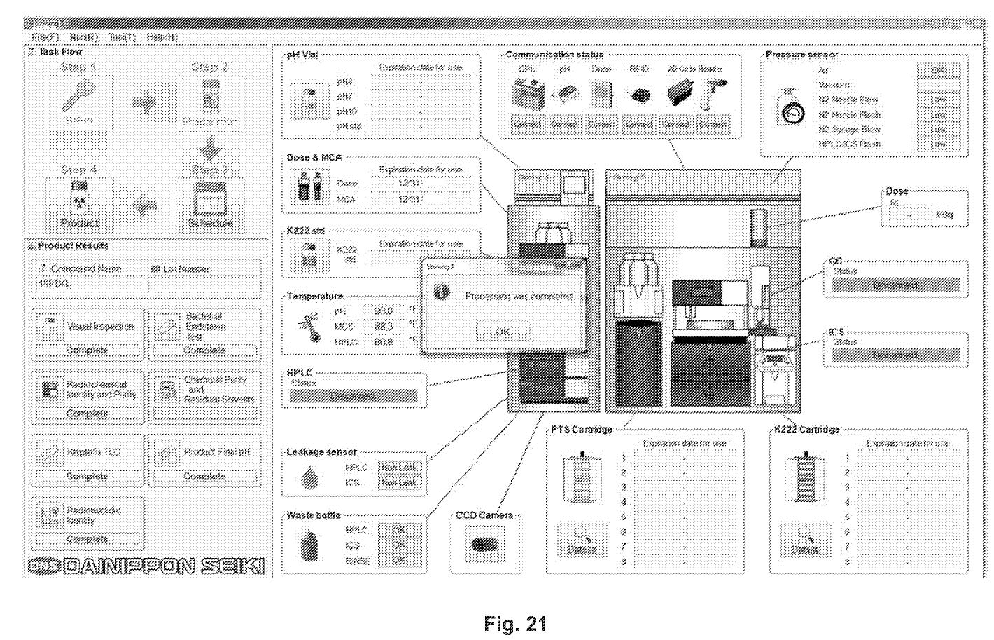

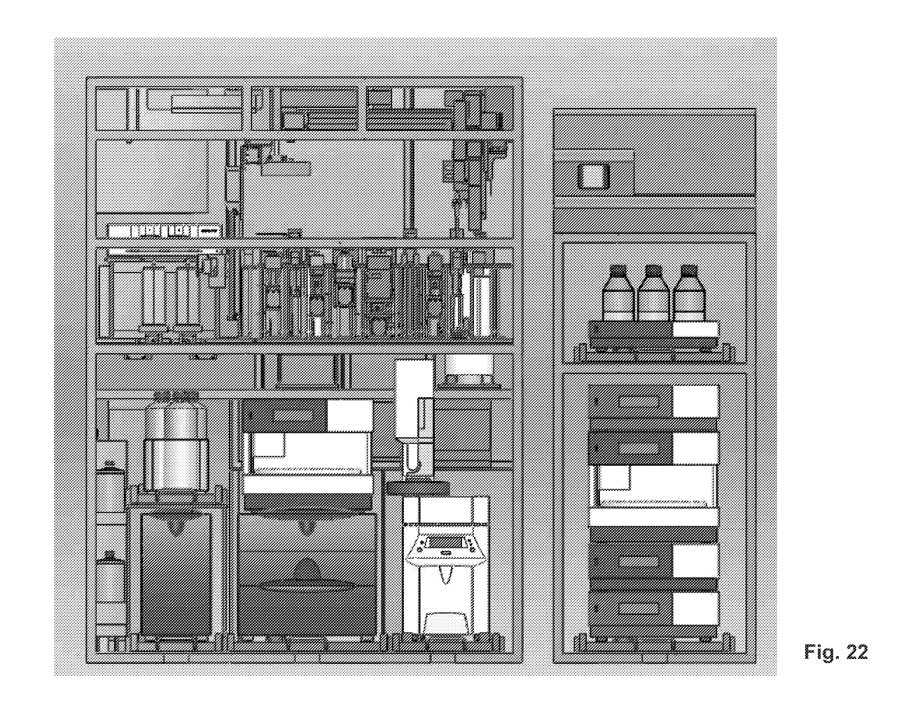

FIGS. 4-21 illustrate a number of screen shots of a graphical user interface (GUI) associated with an automated PET radiopharmaceuticals QC system and apparatus during a sample QC process in accordance with aspects of the present invention. It is understood that each of the performed QC tests may be contemplated in individual modules to enable easy maintenance and replacement when necessary. In some example implementations, it may be desirable to have at least two units (a redundant units, or spare parts) on site for each module, for example.

In some aspects, the GUI may be configured to interact with the various modules/components for providing control information to users. This can include substantially any type of application that sends, retrieves, processes, and/or manipulates input data, receives, displays, formats, and/or communicates output data. For example, such interfaces can also be associated with an engine, editor tool or web browser although other type applications can be utilized. The GUI may include a display having one or more display objects (not shown) comprising, e.g., configurable icons, buttons, sliders, input boxes, selection options, menus, tabs having multiple configurable dimensions, shapes, colors, text, data and sounds to facilitate operations with the interfaces. In addition, the GUI can also include receiving user commands from a mouse, keyboard, laser pointer, speech input, web site, remote web service and/or other devices such as a camera and/or video content to affect or modify operations of the GUI.

Referring to FIG. 4, an example screen shot 400 for a four-step QC process 402 (Setup->Preparation->Schedule->Product) may be contemplated in accordance with aspects of the present invention. It is appreciated, however, that the QC process 402 is not intended to be exhaustive or to limit embodiments of the present invention to the exact steps described herein. Modifications and variations in light of the present invention may be implemented in accordance with the practical QC requirements of each individual sample. In some aspects, the QC process 402 may be customized to overhaul the overall systematic workflow as shown in FIG. 1 such that it may feed through other related internal work flows and the underlying standard operating procedures (SOPs).

As a general illustration of the layout shown in FIG. 4, an HPLC system 404 may be configured to include a six-column switching valve which may allow it to perform QC testing for at least five different compounds. HPLC 404 may also be configured to operate as a high or ultra-high pressure system. For example, in a ultra-high pressure HPLC, columns packed with sub-2 μm particles may be used, and when combined with the elevated operating pressures, can result in a significant reduction in retention times. As a result, with a ultra-high pressure HPLC which is capable of operating at pressures up to 15,000 pound per square inch (PSI), in contrast to about 2000-5000 PSI for a conventional HPLC, analysis times can be significantly decreased when compared to conventional HPLC analysis, thereby improving throughput for high-volume analyses and improving method development time cycles, where it is advantageous to experiment with various method conditions. Implementing a ultra-high pressure HPLC may also help achieve greater sensitivity because of the sharper peak profile and reduced solvent consumption due to the shorter cycle times. Since the peak widths in a ultra-high pressure HPLC can be as much as, e.g., 10 times less than that of traditional HPLC systems, it is also important to reduce the tubing volume to limit peak broadening, upgrade corresponding electronics to accommodate faster data collection and contemplate a much more rapid data collection interface.

An example HPLC system 404 may include an automatic injector (e.g., autosampler), a column compartment, a UV detector, a radiometric detector, and corresponding electronics. Specifically, a column compartment may be used to hold different types of columns, or analytical columns, for conducting HPLC analysis. Dependent upon the types of analysis, the columns may be implemented with different densities, different materials, and different properties. In an aspect, the column compartment may host up to five different types of columns in any time. The UV detector may generally comprise a lamp (e.g., a UV light), a monochromator, a cell, light-detecting element(s), and corresponding electronics. It is known that many organic compounds absorb UV light of various wavelengths. If a beam of UV light shining through the stream of liquid coming out of the column of the HPLC 404, and a UV detector on the opposite side of the stream, one can get a direct reading of how much of the light is absorbed. The amount of light absorbed depends on the amount of a particular compound that is passing through the beam at the time. The output may be recorded as a series of peaks, each one representing a compound in the mixture passing through the detector and absorbing UV light. If the conditions on the column are well controlled, one may use the retention times to help identify the compounds present.

In some aspects, the HPLC 404 also comprises a radiometric detector (not shown) for detecting radioactivity in a certain length of the tubing which allows the fluid to go through. If this section of fluid contains the radioactivity, a big peak from the radiation can be detected based on the intensity of the chemical. In some implementations, if a chemical is studied for radiochemistry purity and chemical purity, one may use both the UV detector and the radiometric detector to verify the results of each other.

An ion chromatography (IC) system 406 is similar to the HPLC system 404 except that the former is made of plastics on the fluid path. Generally, IC 406 may be configured to perform a special quality control based upon the conductivity of the sample. A pump compartment 408 may be implemented to house two individual pumps in any combination of three types of pumps: an insocratic capillary IC pump, an isocratic analytical IC pump and a gradient analytical pump. In general, capillary IC pumps are always isocratic as they deliver one eluent. Analytical IC pumps can be either isocratic or low pressure proportioned gradient. Gradient pumps deliver gradient mixtures of up to four eluent components. The eluent composition selected for a gradient pump can be delivered as isocratic, isocratic proportioned, linear ramp, step, curved, or any combination of these. In some implementations, both pumps in compartment 408 may be gradient pumps, such that both can mix with different solvents contained in a mobile phase 410 based on the proportions required by the QC process. In some aspects, the mobile phase 410 can store at least eight different solvents/bottles.

A pH vial panel 412 may comprise information regarding pH buffer samples used for the QC process 402. A pH unit (not shown) may comprise a pH cell with a micro pH electrode, which is capable of performing micro-liter pH test. A valve may be used to select solutions, including three standard pH buffer solutions, for example, pH 4.01, pH 7.01 and pH 10.01, and an electrode storage solution, as shown in FIG. 4. These three pH standards may be used to routinely calibrate the pH electrode of the pH unit while the storage solution is introduced into the pH unit in case the pH electrode is not in use. In some implementations, the validation information regarding the buffer solutions may be automatically filled in via bar code(s) or database transfer. That is, it is contemplated, in some implementations, that a relational database stores information regarding each sample under study in a form representative of matrices, such as two-dimensional tables, including rows and columns of data, or higher dimensional matrices. For example, in one embodiment, the relational database has separate tables each with a parameter. The tables are linked with a record number, which also acts as an index. The database can be searched or sorted by using data in the tables and is stored in any suitable storage medium, such as floppy disk, CD ROM disk, hard drive or other suitable medium. In some aspects, It can be appreciated that a unique identifier, such as a barcode, that uniquely identifies the syringe/vial may be provided 414 and saved into the database so that the syringe/vial can be tracked at any location/time as it is advanced from one QC testing instrument/location to another. That is, a reader 416 may read and associate the unique identifier 414 with a particular syringe/vial that has been saved in the database. This allows each sample to be uniquely identified and logged into and tracked by a central computer/database.

As shown in FIG. 4, a dose and multi-channel analyzer (MCA) panel 418 may comprise calibration information for one or more QC measurement devices. In one aspect, a MCA may need to be calibrated using two or more radiation sources with known energies. For example, Co-57, Cs-137 are some commonly used calibration sources. MCAs can be programmed so that each channel represents a particular energy increment or unit (usually 1 eV/channel, or 1 keV/channel) depending on the energy range of interest. A MCA calibration sequence may involve acquiring energy spectra of some known sources (each with different photo-peak energies at opposite ends of an energy range of interest), identifying the channels associated with each photo-peak energy, and calculating the eV or keV for each channel. As shown in FIG. 4, the expiration dates for the dose and radioactive sources/isotopes of the MCA may be specified.

A K222 STD panel 420 refers to the information regarding a so-called “cryptofix,” a common solvent used in a synthesis process. It is usually required to ensure such solvent is in compliance with regulatory QC requirements. An ambient temperature reading panel 422 may show the temperature in that vicinity of the QC test.

HPLC status, which is shown in a panel 424 in FIG. 4, generally refers to the link status between the automatic QC machine control computer and the HPLC control computer

A leakage sensor 426 may be implemented to monitor the operating status of each sub-unit involved in a QC process in real-time and provide timely warnings (visual signal, audio signal, or a combination thereof) of detected leakage of a specific sub-unit to an operator. Although only HPLC 404 and ICS 406 are shown in FIG. 4 for sensing potential leakage, it should be appreciated that this functionality may be customized and configured to include any sub-unit involved in a QC process.

In some aspects, a “waste bottle” functionality 428, as one of the QC system design requirements, may be implemented to alert an operator to empty the waste accumulated during various QC processes, based upon, e.g., a scale of the waste bottle.

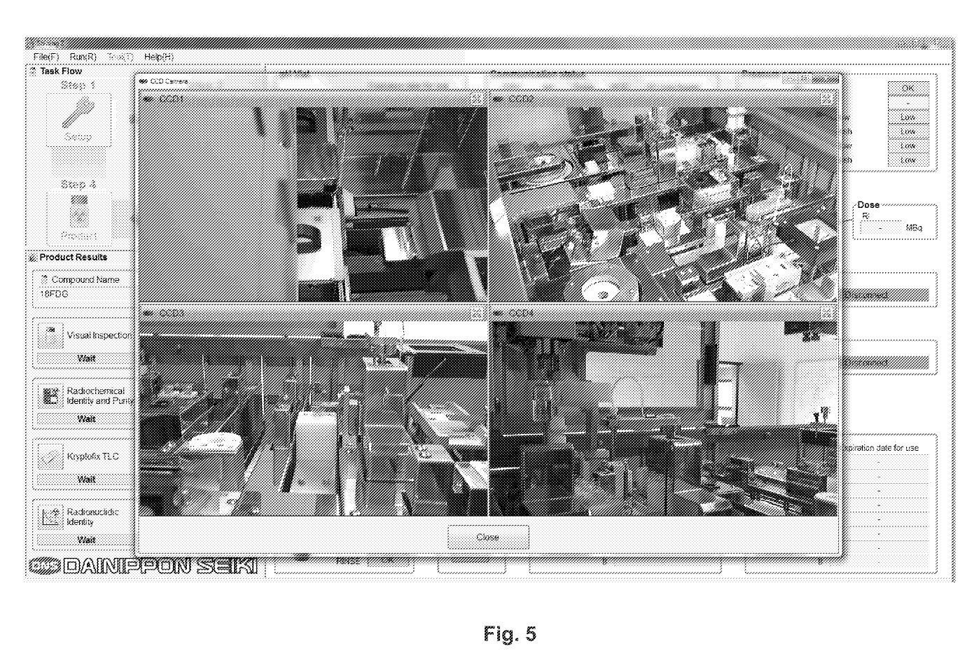

A “CCD camera” icon 430 is used to monitor the overall QC system in a real-time via a number CCD cameras installed at various locations of the QC system. For example, referring to FIG. 5, when the icon 430 is engaged, multiple pictures of the operating QC system may be captured from different perspectives in real-time. This functionality may help an operator monitor each QC measurement device for its intended use. In the meantime, the recorded images may be time-stamped and saved into a central control device/database (e.g., control device 236 in FIG. 2) for references purposes such that questions regarding a particular batch or a performed sequence may be adequately addressed.

Now referring back to FIG. 4, a communication status 432 may comprise a CPU icon 434 for representing the status of a central control computer for all of the robots and QC modules. Illustrated in FIG. 4 are also a pH meter 436, a dose icon 450, a RFID icon 438, a 2D Code icon 414 and a reader 416. Every icon may be used to show the communication link between its associated computer and the central control computer. In some aspects, the RFID 438 may operate with a RFID reader 416 via linking with a security system (not shown) for personal identification, such that only authorized users may be granted access to the QC system and the information maintained therein. Instead of requiring a user to enter password, it may be more efficient to use the RFID. In one example, a security system may include various RFID identification badges and/or passes such that each pass or badge utilizes an RFID tag with unique identification data. By employing RFID technology, the location of each badge and/or pass may be ascertained and, in turn, the location of any individual wearing and/or utilizing a badge or pass can be identified. For example, if it is detected that a RFID embedded badge and/or pass is within a hazardous area, zone, and/or location, a safe mode may be initiated automatically. For another example, when a person utilizing the badge comes into a room with various hazardous devices, the room and/or the devices located within may be forced into a safe mode such that the room and/or proximity related to the devices and/or room may be deemed a protected zone. In addition, RFID passes and/or badges may include a hierarchy of security rights and/or privileges such that particular locations within an industrial automation environment may be entered or denied based on such privileges and/or security rights. Thus, the RFID passes and/or badges may be employed to provide automatic access and/or automatically deny access to various locations, instruments, databases, etc. Moreover, the RFID passes and/or badges may ensure the appropriate person is accessing and/or is denied access to a location by utilizing various authentication measures and/or biometric data saved within the badge and/or pass (e.g., facial recognition, fingerprint recognition, and iris recognition). Further, RFID may also be used to check inventory of materials other than human identification.

A “2D code” icon 414, or a bar code reader, may be implemented to read small labels on various samples and devices. The reader 414 may be a handheld reader/device with a USB connector.

A pressure sensor module and panel 440 as shown in FIG. 4 may direct compressed air driving the QC system. The corresponding pressure sensing modules may comprise various pressure gauges for monitoring the pressures of various gases used for moving various solvents along different QC devices and in compliance with corresponding regulatory requirements.

A dose module and indicator 442 may be contemplated as a real-time dose calibrator. It may also link to a dose calibrator well. GC 444 refers to the gas chromatography and ICS 406 refers to the ion chromatography. In one aspect, the ICS 406, instead of using UV detector, uses a conductivity detector for measuring the conductivity of the solvent to determine a status change.

A portable testing system (PTS) cartridge 446, which is also illustrated in FIG. 4, may be used to test the existing endotoxins in a test sample. A K222 cartridge 448 refers to a cryptofix test cartridge.

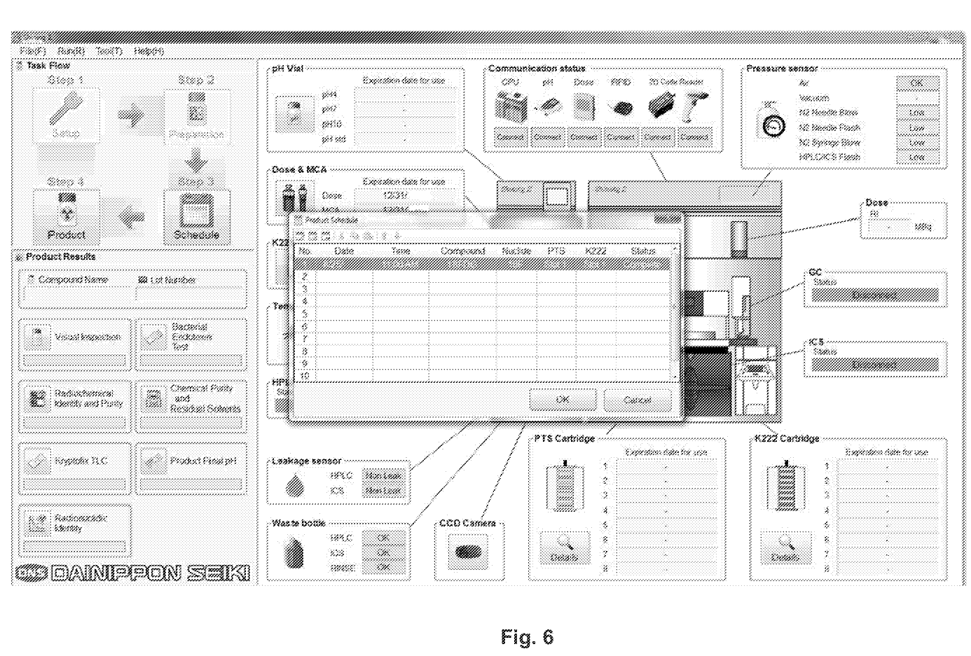

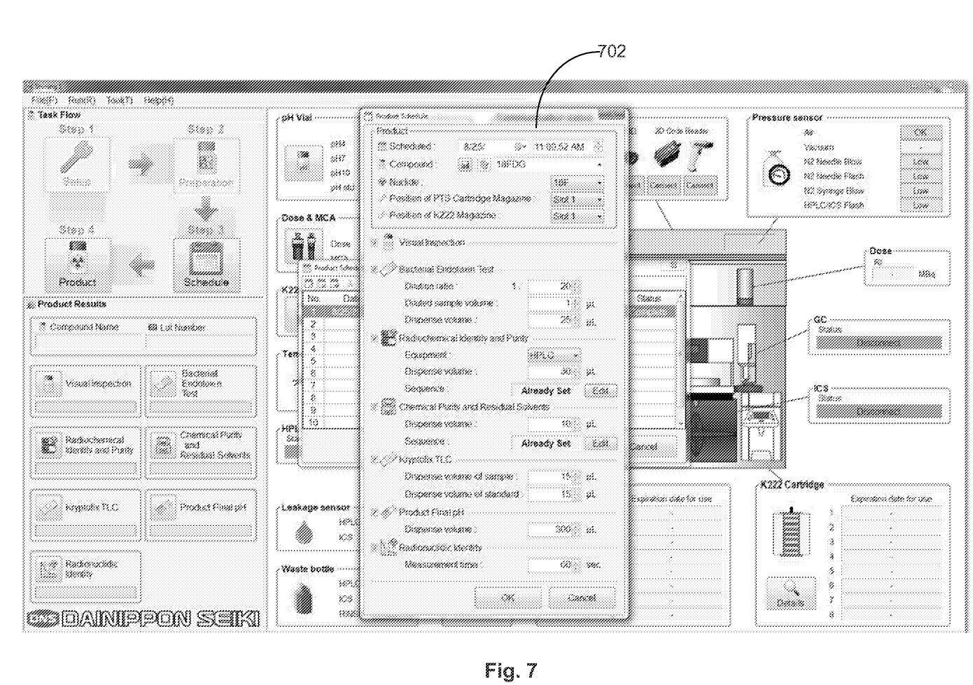

Now referring to FIGS. 6-8, an example QC process may begin by prompting a user to enter test parameters. It will be appreciated that the information displayed may be subject to change based on practical QC requirements for each individual sample. For example, referring to FIGS. 6-7, an operator may enter a compound name and select desired QC tests for the compound including “visual inspection,” “bacterial endotoxin test,” “radiochemical identity and purity,” “chemical purity and residual solvents,” “kryptofix TLC,” “product final pH,” and “radionuclidic identity,” by checking associated checkboxs. The operator may also be prompted to determine which position of the PTS cartridge and the K222 magazine are assigned to perform the selected QC tests. For example, as shown in FIG. 7, “Slot 1” in the respective PTS cartridge and K222 magazine is specified. Alternatively, in some aspects, all of the QC tests may be preprogrammed based on the compound that is going to be tested, and all of the test parameters may be automatically obtained and populated from corresponding QC measurement device, thereby allowing the operator to simply scan an identifier of the sample (e.g., a bar code 414 or RFID 416) to initiate the QC process. With a fully automated QC system, an operator may simply be instructed by the system to put, e.g., solvent A in position 1 of a first QC instrument, or solvent B in position 2 of a second QC instrument in the amount specified by the system. However, an operator may be allowed to overwrite/modify the parameters suggested by the system in accordance with each specific QC test, as shown in FIG. 7. In some aspects, in order to minimize the human intervention/error, the solvent preparation step, which is usually performed manually, may be replaced by dispensing pre-packaged, standard solvent packs in the required concentration and dose from a centralized location using robotics.

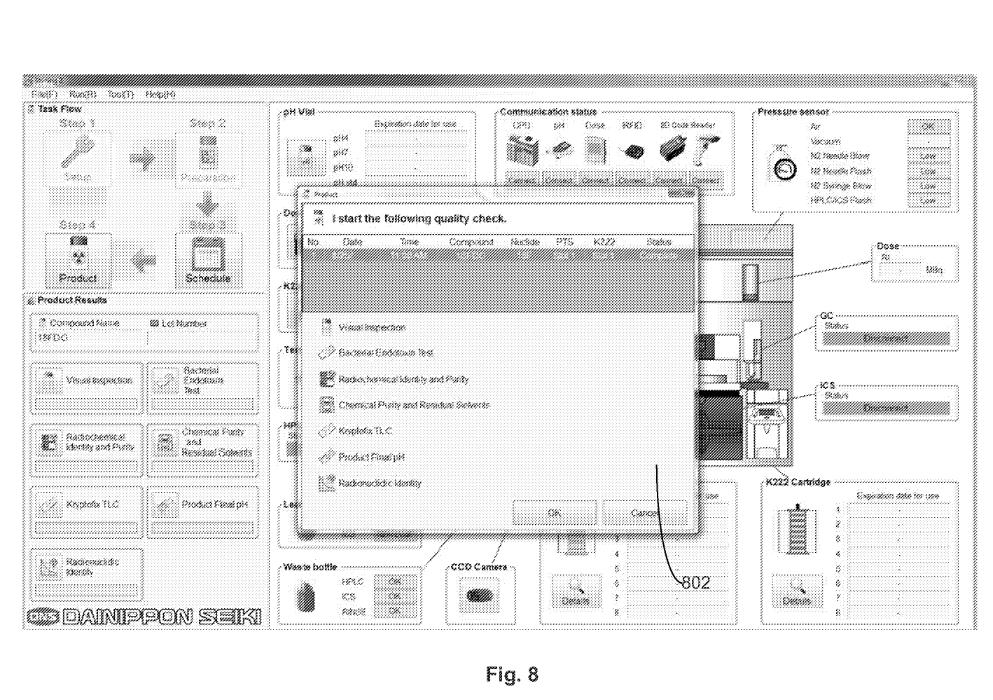

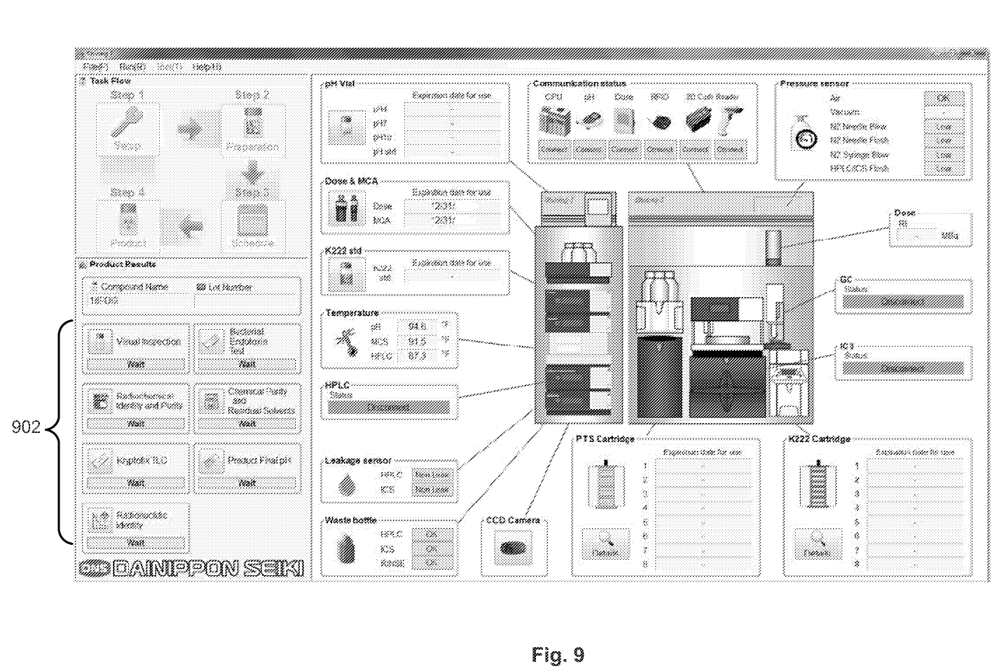

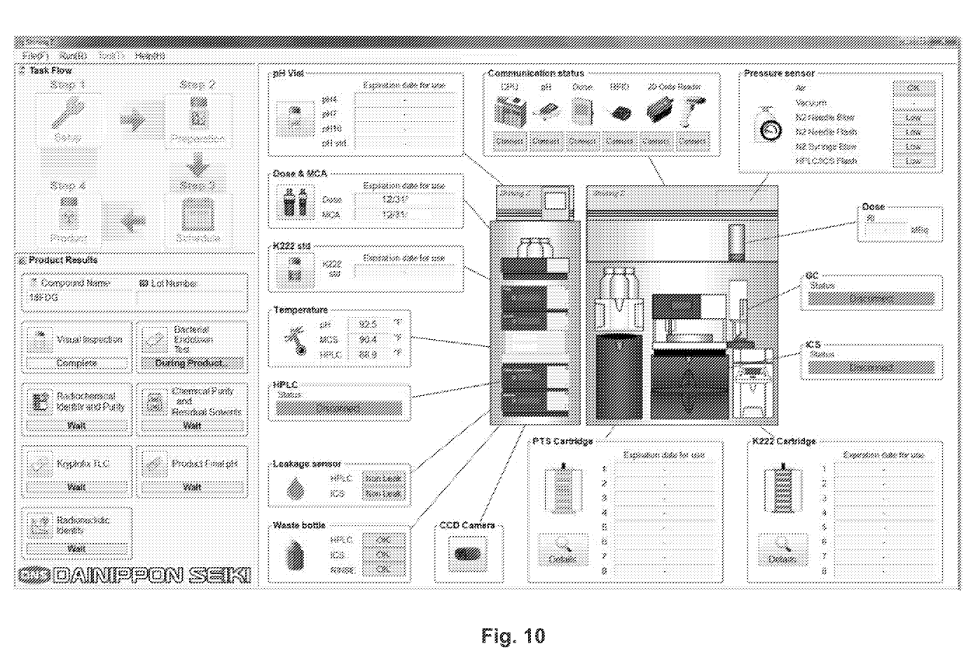

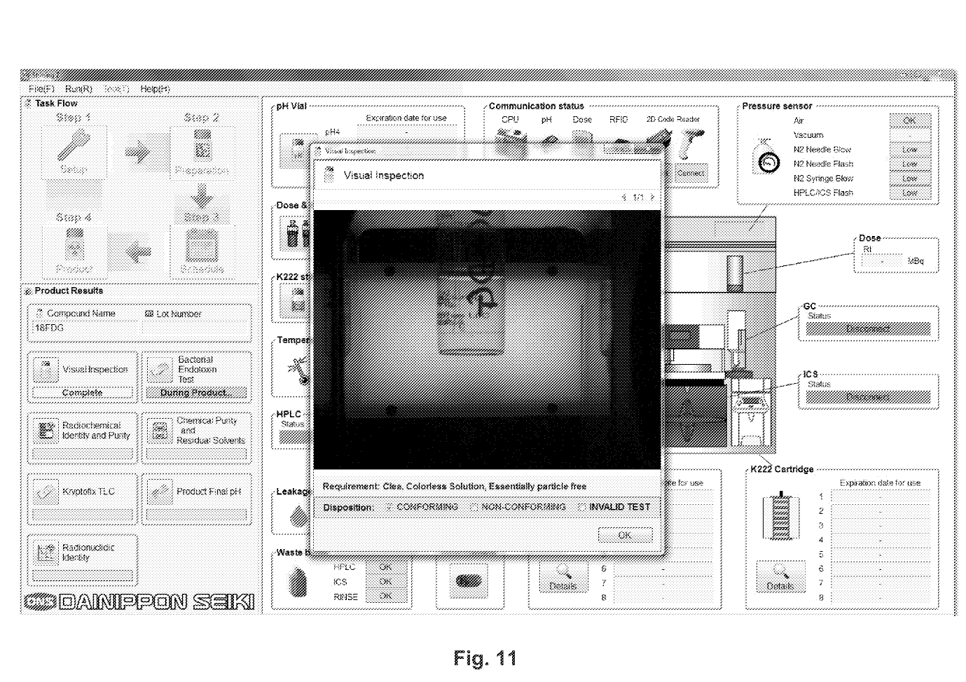

Once the preparation list 702 is finished and entered, a confirmation screen 802 as shown in FIG. 8 may pop up, and the underlying control unit of the QC system may subsequently activate corresponding QC instruments to begin the user selected QC tests. For example, as shown in the left side panel 902 of FIG. 9, all of the seven selected QC tests and the corresponding measurement instruments are initialized and calibrated. In some implementations, the CCD camera icon 430 in FIG. 4 may be automatically activated to record the overall QC process from start to end for record keeping purposes (see also FIG. 5). FIGS. 10-21 additionally show various GUI screens of the QC system disclosed herein in accordance with aspects of the present invention.

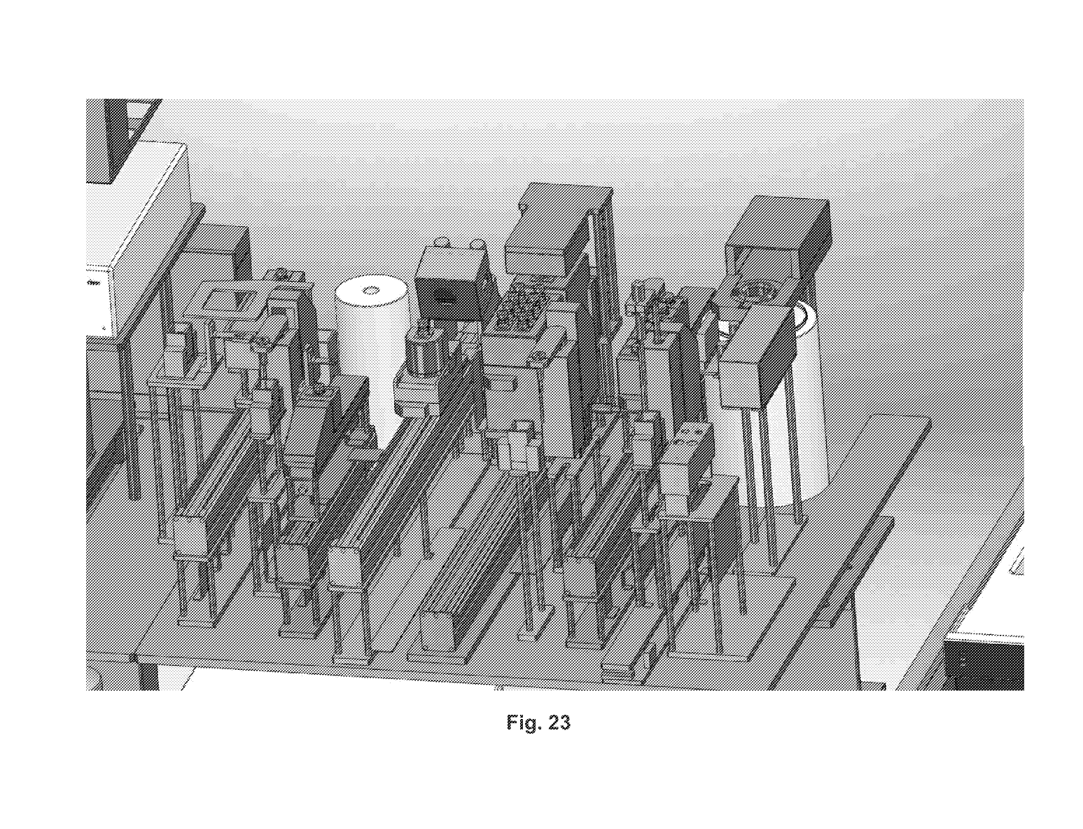

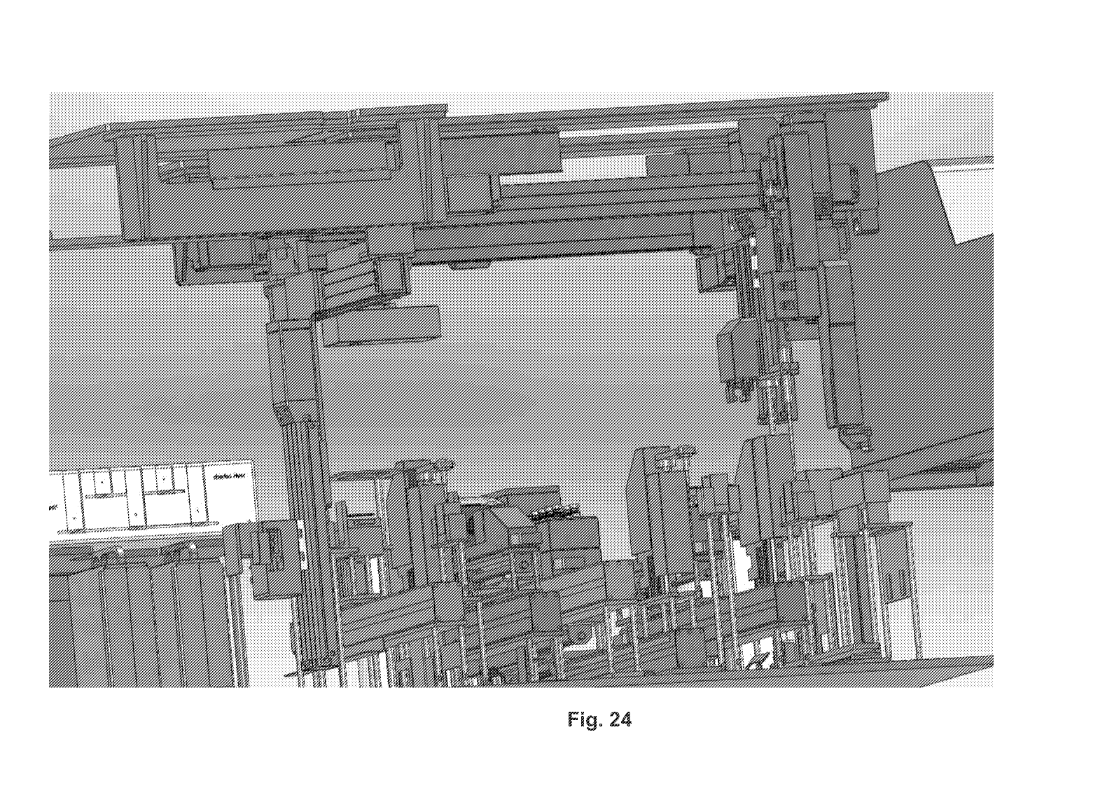

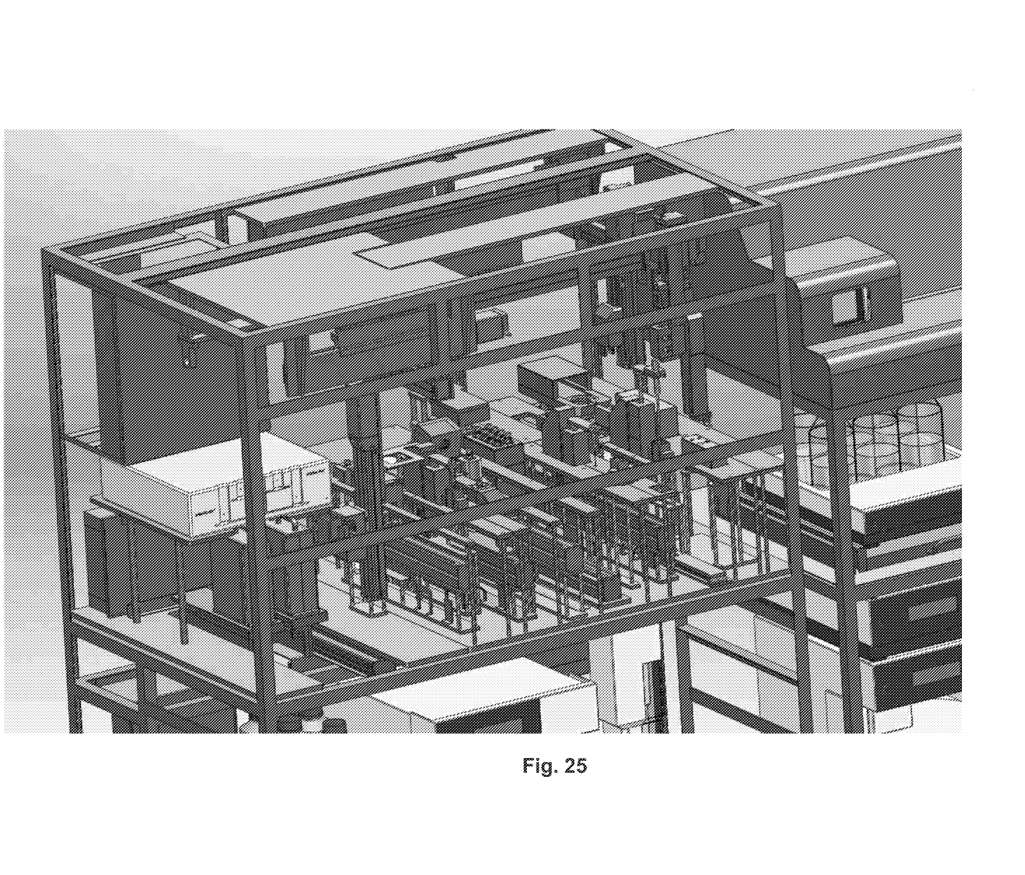

In some implementations, referring to FIGS. 22-25, robotics may be used to perform routines in automated sample preparation and automated QC operations in accordance with aspects of the present invention. For example, a mechanical arm may open up the storage and put a cassette into a medium container and then insert a final cassette into a slot. In the meantime, the QC system may be taking a picture of the sample for visual inspection as shown in FIGS. 10-11 using a computer based visual inspection system; while another robot may carry out certain preparation steps by inserting a cartridge into, e.g., the PTS cartridge and/or the K222 magazine slot.

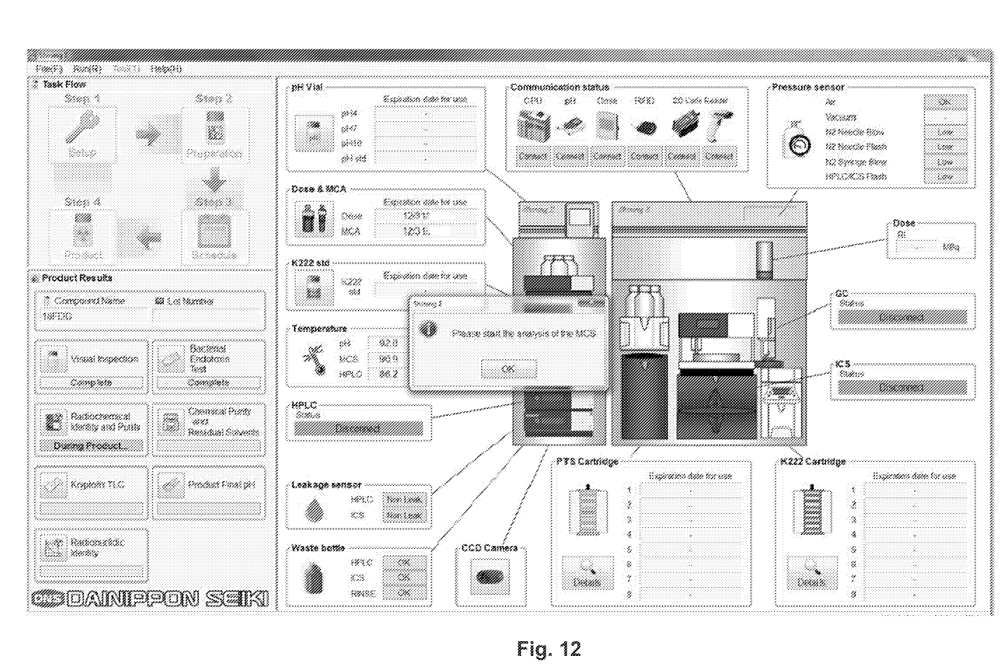

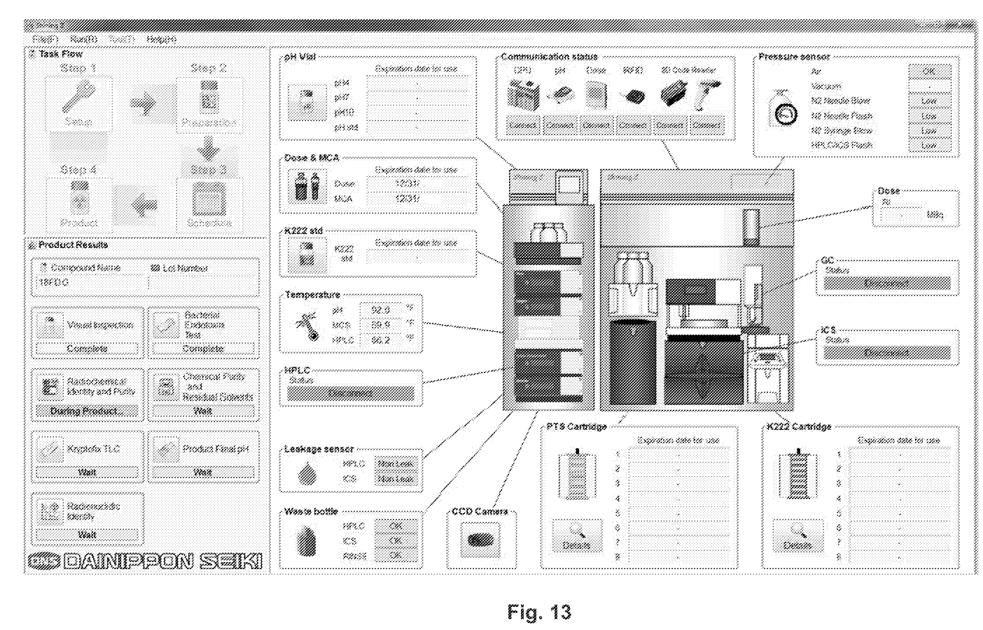

In some implementations, when a first syringe is diluting a sample at a designated location of the QC system, another syringe driver controlled by a robot may be driving a second syringe to extract the sample under study, puncture the septum, push a reagent into a vial, and dispose the waste. It should be appreciated that the work flow sequence of a QC process may be preferably configured to parallelize multiple QC preparation and operation steps thereby minimizing the testing time by coordinating multiple robots with various underlying QC instruments, as shown in FIGS. 12-21. Further, more than one product may be tested in parallel.

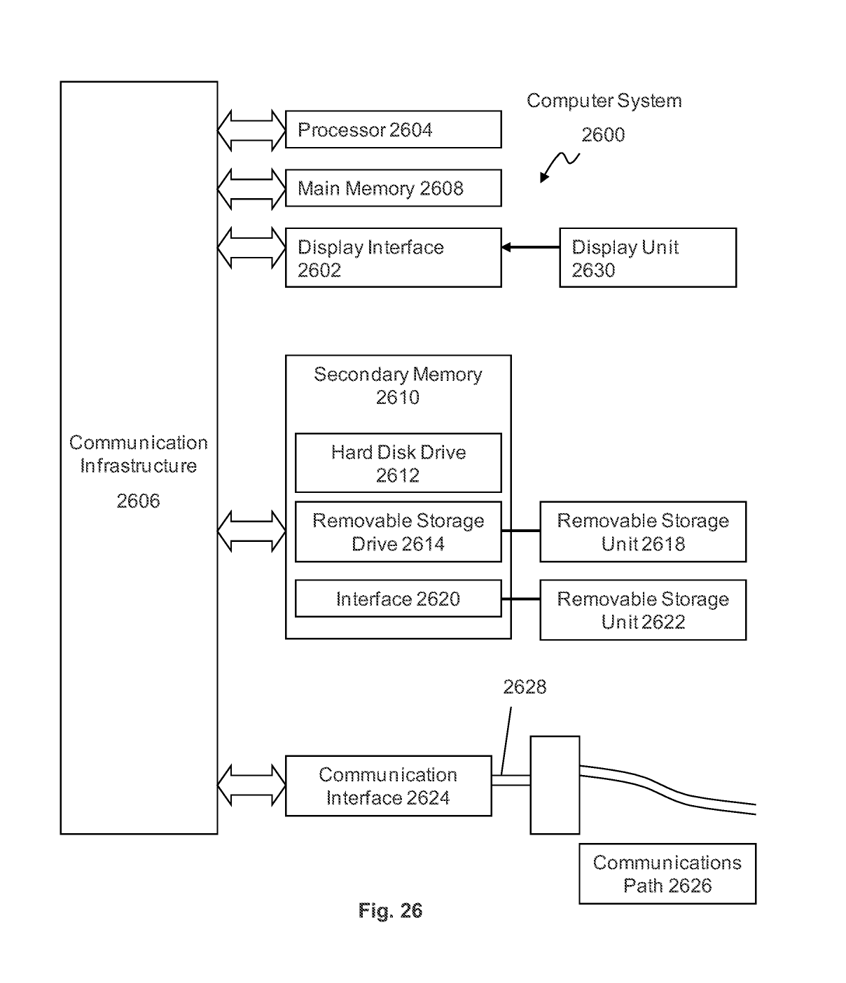

In some variations, aspects of the present invention may be directed toward one or more computer systems capable of carrying out the functionality described herein. An example of such a computer system 2600 is shown in FIG. 26.

Computer system 2600 includes one or more processors, such as processor 2604. The processor 2604 is connected to a communication infrastructure 2606 (e.g., a communications bus, cross-over bar, or network). Various software aspects are described in terms of this exemplary computer system. After reading this description, it will become apparent to a person skilled in the relevant art(s) how to implement the invention using other computer systems and/or architectures.

Computer system 2600 can include a display interface 2602 that forwards graphics, text, and other data from the communication infrastructure 2606 (or from a frame buffer not shown) for display on a display unit 2630. Computer system 2600 also includes a main memory 208, preferably random access memory (RAM), and may also include a secondary memory 2610. The secondary memory 2610 may include, for example, a hard disk drive 2612 and/or a removable storage drive 2614, representing a floppy disk drive, a magnetic tape drive, an optical disk drive, etc. The removable storage drive 2614 reads from and/or writes to a removable storage unit 2618 in a well-known manner. Removable storage unit 2618, represents a floppy disk, magnetic tape, optical disk, etc., which is read by and written to removable storage drive 2614. As will be appreciated, the removable storage unit 2618 includes a computer usable storage medium having stored therein computer software and/or data.

In alternative aspects, secondary memory 2610 may include other similar devices for allowing computer programs or other instructions to be loaded into computer system 2600. Such devices may include, for example, a removable storage unit 2622 and an interface 2620. Examples of such may include a program cartridge and cartridge interface (such as that found in video game devices), a removable memory chip (such as an erasable programmable read only memory (EPROM), or programmable read only memory (PROM)) and associated socket, and other removable storage units 2622 and interfaces 2620, which allow software and data to be transferred from the removable storage unit 2622 to computer system 2600.

Computer system 2600 may also include a communications interface 2624. Communications interface 2624 allows software and data to be transferred between computer system 2600 and external devices. Examples of communications interface 2624 may include a modem, a network interface (such as an Ethernet card), a communications port, a Personal Computer Memory Card International Association (PCMCIA) slot and card, etc. Software and data transferred via communications interface 2624 are in the form of signals 2628, which may be electronic, electromagnetic, optical or other signals capable of being received by communications interface 2624. These signals 2628 are provided to communications interface 2624 via a communications path (e.g., channel) 2626. This path 2626 carries signals 2628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 2614, a hard disk installed in hard disk drive 2612, and signals 2628. These computer program products provide software to the computer system 2600. The invention is directed to such computer program products.

Computer programs (also referred to as computer control logic) are stored in main memory 2608 and/or secondary memory 2610. Computer programs may also be received via communications interface 2624. Such computer programs, when executed, enable the computer system 2600 to perform the features of the present invention, as discussed herein. In particular, the computer programs, when executed, enable the processor 2610 to perform the features of the present invention. Accordingly, such computer programs represent controllers of the computer system 2600.

In an aspect where the invention is implemented using software, the software may be stored in a computer program product and loaded into computer system 2600 using removable storage drive 2614, hard drive 2612, or interface 2620. The control logic (software), when executed by the processor 2604, causes the processor 2604 to perform the functions of the invention as described herein. In another aspect, the invention is implemented primarily in hardware using, for example, hardware components, such as invention specific integrated circuits (ASICs). Implementation of the hardware state machine so as to perform the functions described herein will be apparent to persons skilled in the relevant art(s).

In yet another aspect, variations of the invention may be implemented using a combination of both hardware and software.

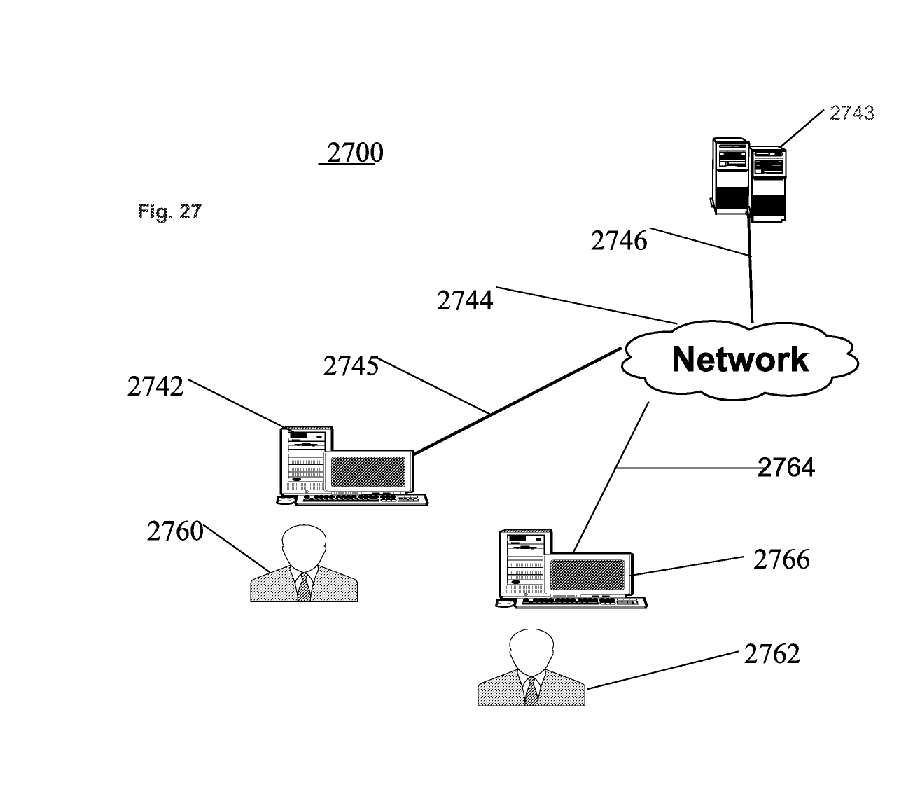

FIG. 27 shows a communication system 2700 involving use of various features in accordance with aspects of the present invention. The communication system 2700 includes one or more assessors 2760, 2762 (also referred to interchangeably herein as one or more “users”) and one or more terminals 2742, 2766 accessible by the one or more accessors 2760, 2762. In one aspect, operations in accordance with aspects of the present invention is, for example, input and/or accessed by an accessor 2760 via terminal 2742, such as personal computers (PCs), minicomputers, mainframe computers, microcomputers, telephonic devices, or wireless devices, such as personal digital assistants (“PDAs”) or a hand-held wireless devices coupled to a remote device 2743, such as a server, PC, minicomputer, mainframe computer, microcomputer, or other device having a processor and a repository for data and/or connection to a repository for data, via, for example, a network 2744, such as the Internet or an intranet, and couplings 2745, 2764. The couplings 2745, 2764 include, for example, wired, wireless, or fiberoptic links. In another aspect, the method and system of the present invention operate in a stand-alone environment, such as on a single terminal.

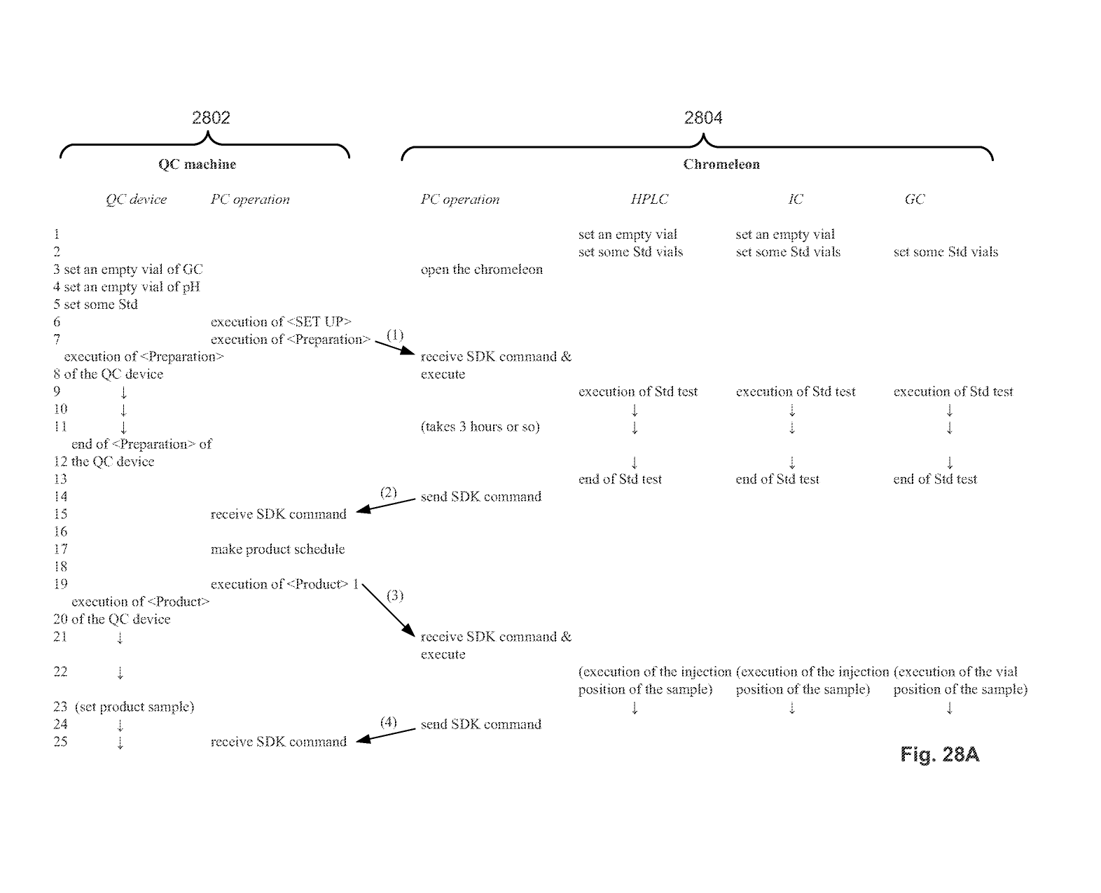

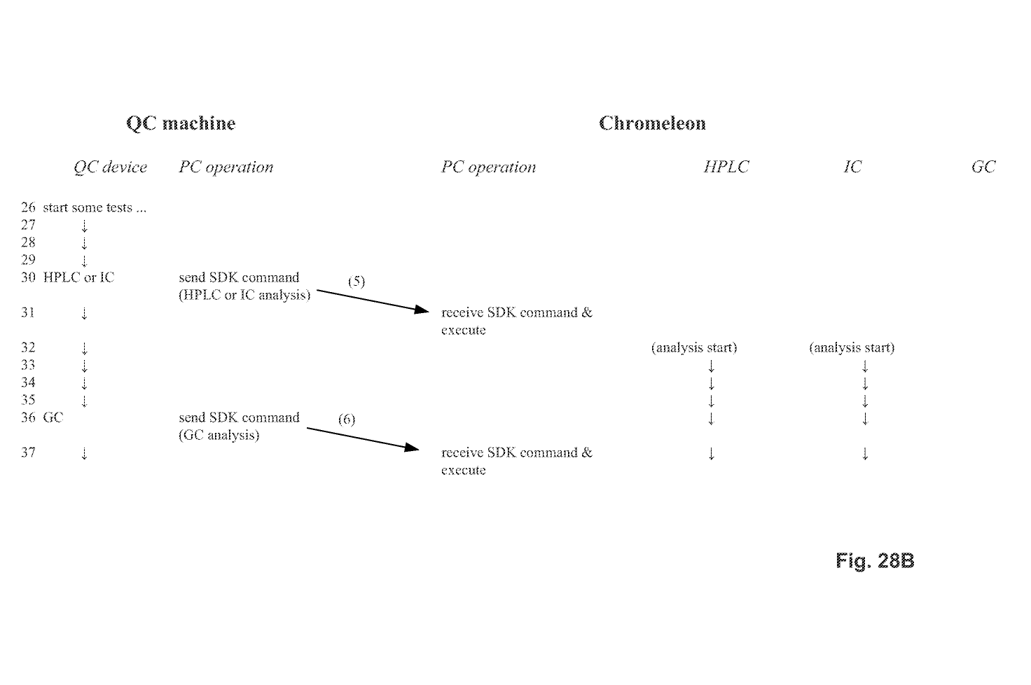

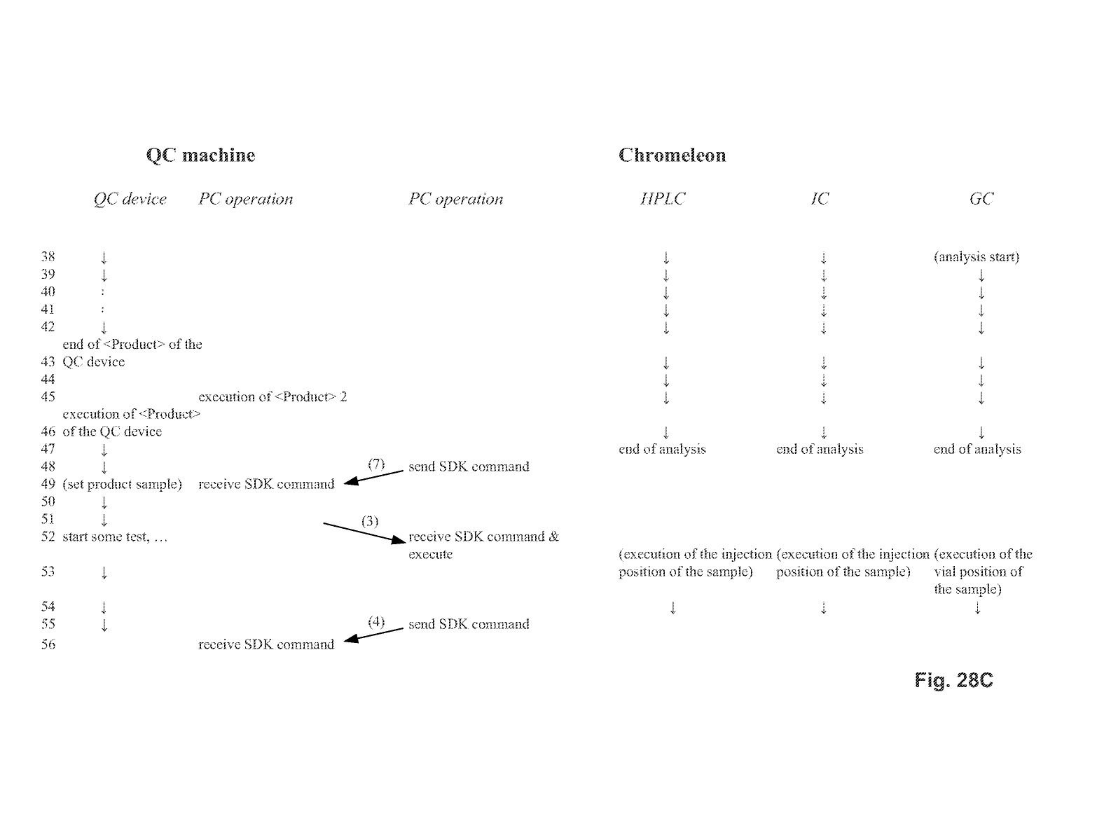

Referring now to FIGS. 28A-C, therein illustrated is an example overall control process of an automated QC system and apparatus coordinating various testing instruments for preparing and performing a plurality of selected QC tests tailored to a specific radiopharmaceutical, in accordance with aspects of the present invention. In one aspect, as shown in FIGS. 28A-C, a left column 2802 shows an automated QC machine and its associated control device (e.g., a QC PC) interacting and exchanging signals with an HPLC machine, IC machine, GC machine such as via an associated control device (e.g., a PC associated with a control program, such as e.g., Chromeleon® Chromatography Software made by Dionex of Thermo Fisher Scientific) that are grouped under a right column 2804. It should be appreciated that the control in the right column 2804 may relate to more QC related devices and/or different testing instruments subjected to defined tests. In some implementations, each testing instrument may be a stand-alone device with data collecting and computing capabilities, and a systematic level control module and user interface (e.g., Chromeleon®) may be configured to couple and interconnect multiple QC related devices and testing instruments to provide streamlined lab routine management with reduced human errors.

Starting with steps 1-7 of FIGS. 28A-C, both the QC machine of the left column 2802 and the group of the testing instruments as controlled in the right column 2804 may position/set empty vials for selected QC tests. For example, the HPLC and IC machines may position a particular vial in each respective autosampler and set standard solution vials accordingly. It should be appreciated that the time sequence labels on the leftmost side of FIGS. 28A-C are used to show an example occurring order of the operations of the various devices/modules as governed in the left and right columns 2802 and 2804, and may vary in accordance with a specific QC test. In one aspect, as shown in step 3, while the QC machine sets an empty vial for the GC, in addition to setting the pH and solution vials, the systematic level control module and user interface may be initiated to start interconnecting the relevant testing instruments and communicate with the QC machine by exchanging data/control signals therebetween. For example, as shown in arrow (1) in FIG. 28A, the QC machine may transmit “SET UP” and “Preparation” commands to the systematic level control module of the testing machines of the right column 2804, such that each instrument may be directed automatically to commence its own standard test against the specific reference standards/benchmarks to which it is subjected. The execution time for these standard tests may vary depending upon the defined the tests and selected instruments. Note that preparing various testing instruments for a QC test scheduled on a specific date is performed automatically, thereby providing an efficient and optimized workflow tailored to specific pharmaceuticals. Upon detecting a successful completion of all the standard tests, a notification (e.g., arrow (2)) may be forwarded to the QC machine which in turn may make product schedule(s) for the day (step 17). It should be noted that, in some variations, in accordance with aspects of the present invention, multiple products may be tested simultaneously on a same scheduled test date with each individual test being performed in parallel with the remaining steps. In one aspect, as shown in steps 20-43, the QC machine may instruct the HPLC/IC/GC machines of the right column 2804 to start testing Product 1. For example, in steps 20-26, the original vial may be split and distributed to different locations within the system, and the HPLC/IC/GC machines may be orchestrated by the QC machine to start testing. Some tests (step 26) may be conducted within the QC machine via, e.g., a QC robot (e.g., pH test). Further, as shown in steps 32-47, tests may be independently conducted within respective HPLC, IC, and GC machines in parallel to one another. In the meantime, prior to the end of the analysis of the three tests, for example, the QC machine at step 45 may initiate testing of Product 2 by setting the product sample and conducting the pH test within itself. The vial of Product 2 may then be split and distributed to the HPLC, IC, and GC machines or other instruments, for example, when each of them become available for intended tests. The availability and suitability of each machine may be monitored and controlled in real time by the systematic level control module and user interface (e.g., Chromeleon® Chromatography Software), which can be configured to communicate such information with the QC machine via, e.g., bi-directional wired or wireless communication channels established there between. As such, the QC machine may be allowed to dynamically assign tasks to each individual QC testing instrument based on its operation status (e.g., availability and suitability).

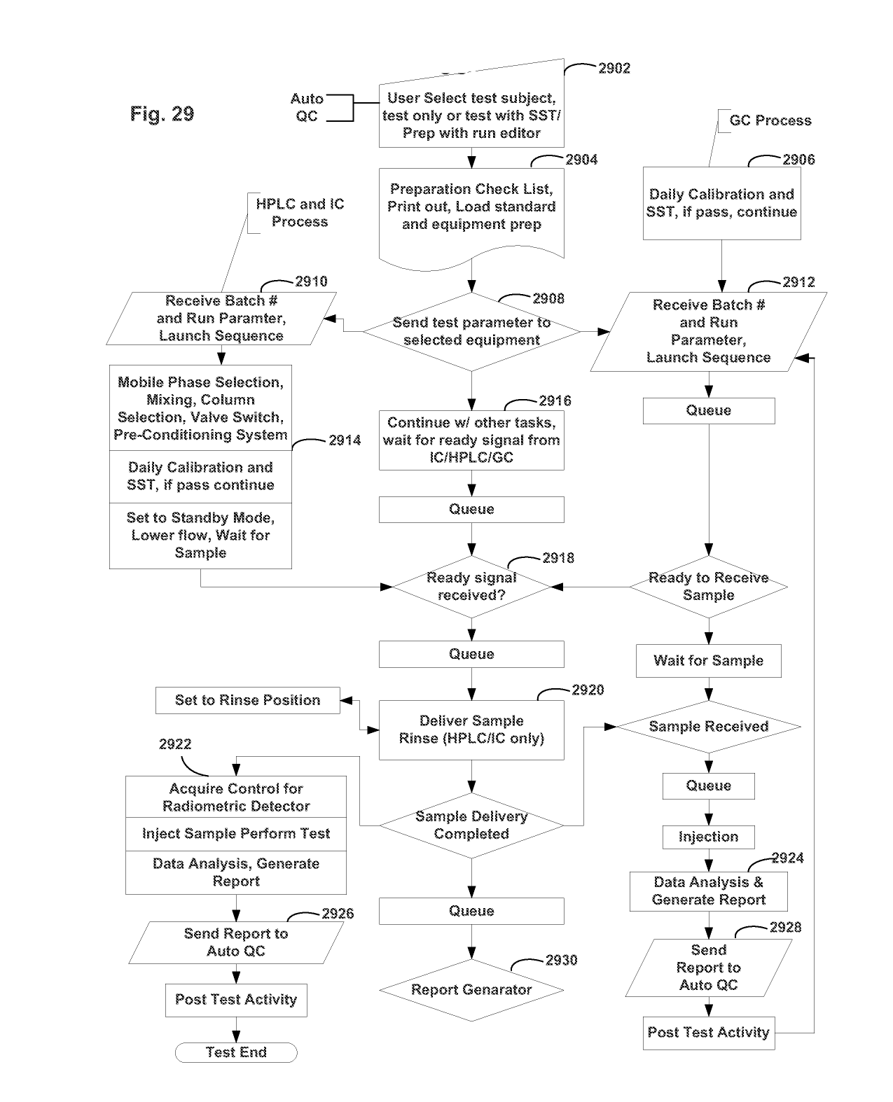

Referring now to FIG. 29, therein illustrated is an example analytical QC control process in accordance with aspects of the present invention. In one aspect, the illustrated example operations and interactions may take place between the automated QC machine and the HPLC, IC, and GC machines during the QC process of FIGS. 28(a)-(c) described above. For example, the QC machine may start 2902 a system suitability test (SST), load standards and prepare equipment 2904 for testing. SST may be used, for example, to verify resolution, column efficiency, and repeatability of a chromatographic system to ensure its adequacy for a particular analysis. According to the United States Pharmacopeia (USP) and the International Conference on Harmonization (ICH), SST is an integral part of many analytical procedures. SST is based on the concept that the equipment, electronics, analytical operations, and samples to be analyzed constitute an integral system that can be evaluated as a whole. The chromatographic systems used for many pharmaceutical analyses, such as assays of the active ingredients, impurity determinations, and dissolution testing (measuring the dissolution rate for a particular form of dosage) must pass a set of predefined acceptance criteria (SST limits) before sample analysis can commence. System suitability differs from operational qualification, which may be, for example, used to demonstrate that all or many components of the instrument, and/or the complete instrument system, are meeting performance standards (i.e., specifications). The testing methodology for operational qualification may be specific to instrumental performance. Unlike operational qualification, SST may be method specific. That is, the system, which is already qualified, may be tested using the test conditions described in the method. Operational qualification ay focus on analytical instrument performance. System suitability, however, may encompass the complete testing system, including instrument, reagents, columns and analysts. As shown in FIG. 29, it may be important to ensure that all of the QC analytics testing instruments undergo daily calibration and SST (e.g., block 2906 for the GC and block 2914 for the HPLC and IC) to ensure the adequacy of the overall testing system. At block 2908, the automated QC machine may exchange control signals and operation status (e.g., in real time) with the HPLC, IC, and GC machines by sending corresponding test parameters, such that each machine receives a batch number and is able to run parameters and launch sequences accordingly (e.g., blocks 2910 and 2912). As part of the SST, the HPLC may remove the analytical HPLC column in order to remove its contribution to the variability of the system, for example, and a simple mobile phase may be selected for the HPLC system.

Once successfully passing the SSTs, control logic of the HPLC, IC, and GC machines may notify the QC machine (block 2918) and prepare to receive samples. Accordingly, the QC machine may start distributing sample vials and instructing one or more testing machines to start rinse cycles (block 2920). Thereafter, various QC tests may be performed in each QC machine (e.g., in parallel) (blocks 2922 and 2924), test reports may be generated (blocks 2926 and 2928) and provided to the QC machine upon completion. At block 2930, the QC machine may collect some or all of the available testing information to generate a consolidated report, which may, for example be readily transmitted to remote locations/facilities that share the same network with the QC machine.

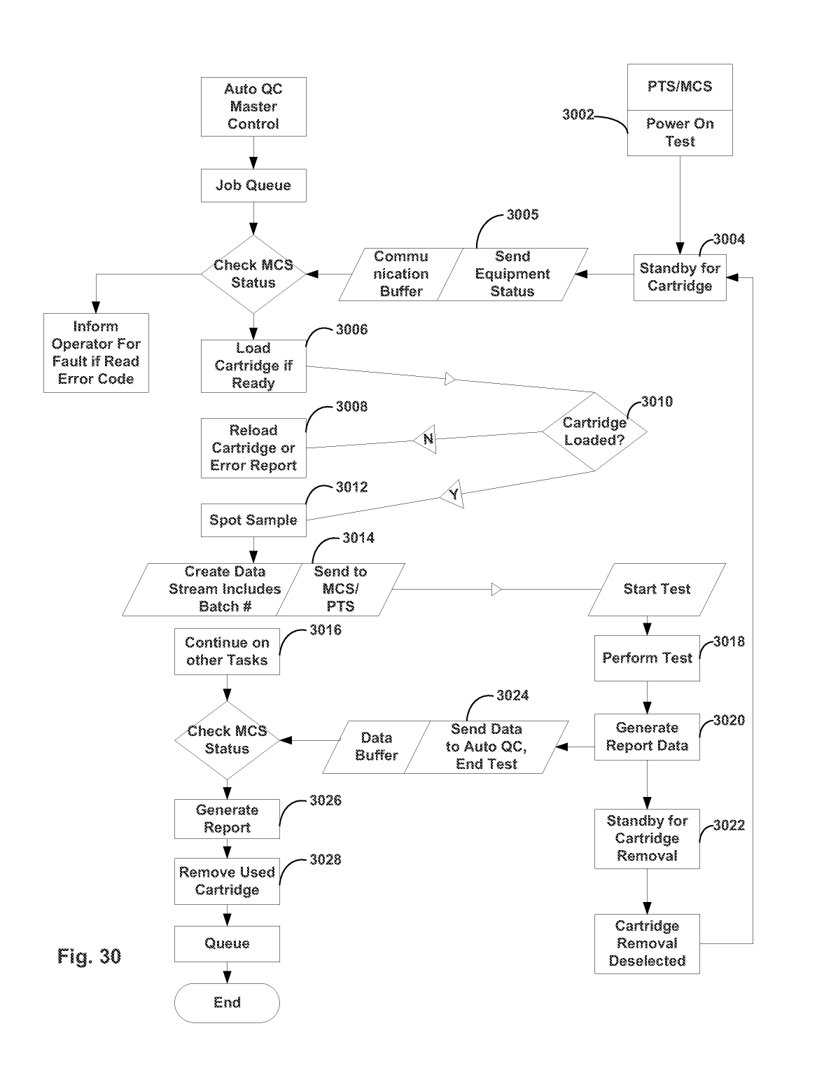

Referring now to FIG. 30, therein illustrated is an example communication flow chart showing operations and interactions between an automated QC machine and an example portable testing system (PTS)/multi-cartridge endotoxin detection system (MCS) provided by Charles River Laboratories, in accordance with aspects of the present invention. In one aspect, the MCS system may include multiple (e.g., five) individual spectrophotometers built into a unit with a single Universal Serial Bus (USB) connector that links to another computer device (e.g., a PC). The MCS may use a Limulus Amebocyte Lysate (LAL) kinetic chromogenic methodology, for example, that measures color intensity that may be directly related to the endotoxin concentration in a sample. Disposable cartridge of the MCS used to run an assay may contain required amounts of LAL reagent, chromogenic substrate and/or control standard endotoxin (CSE). At blocks 3002 and 3004, the PTS/MCS machine powers up and stands by for cartridge load. Equipment status may be temporarily stored in a communication buffer and forwarded (block 3005) to the QC machine at an appropriate time. The QC machine may determine if the PTS/MCS machine is ready and suitable for cartridge loading based on the received equipment status, and initiate loading and/or reloading the cartridges via exchanging handshake signals with the PTS/MCS machine (blocks 3006-3010), for example. Upon successfully loading the cartridge within the MCS, the QC machine may spot the sample 3012 and accordingly create date, stream including batch numbers, etc. 3014 for forwarding to the PTS/MCS. While, for example, the PTS/MCS is performing the scheduled test based on the received information from the QC machine and is generating test report (blocks 3018-3022), the QC machine may perform other tasks (block 3016). It should be appreciated that multiple samples may be tested contemporaneously and independently within the MCS. Test report and/or other test related information may be temporarily stored in a data buffer and forwarded (block 3024) to the QC machine at the appropriate time. Upon receiving suitable information, the QC machine may compile a consolidated report (block 3026) and instruct the PTS/MCS machine to remove the used cartridge (block 3028) to end the LAL test.

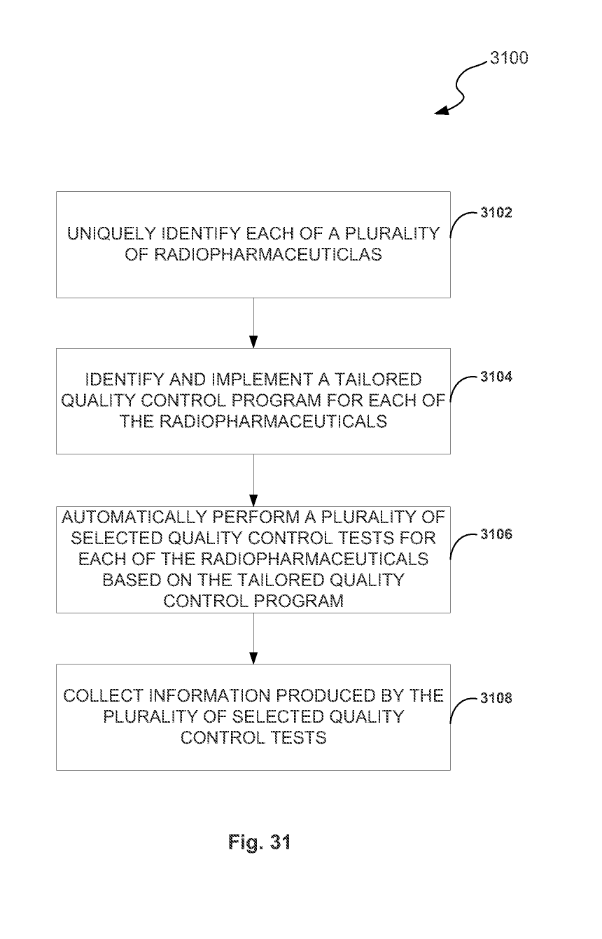

FIG. 31 illustrates a flow diagram for performing automated quality control analysis of a plurality of radiopharmaceuticals, in accordance with an aspect of the present invention. The method includes uniquely identifying 3102 each of the plurality of radiopharmaceuticals, and identifying and implementing 3104 a tailored quality control program for each of the radiopharmaceuticals. The method further includes automatically performing 3106 a plurality of selected quality control tests for each of the radiopharmaceuticals based on the tailored quality control program, and collecting 3108 information produced by the plurality of selected quality control tests.

While this invention has been described in conjunction with the exemplary aspects outlined above and further described in the figures, various alternatives, modifications, variations, improvements, and/or substantial equivalents, whether known or that are or may be presently unforeseen, may become apparent to those having at least ordinary skill in the art. Accordingly, the exemplary aspects of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for performing automated quality control analysis of a plurality of radiopharmaceuticals, the method comprising:
uniquely identifying each of the plurality of radiopharmaceuticals;
identifying and implementing a tailored quality control program for each of the radiopharmaceuticals;
automatically performing a plurality of selected quality control tests for each of the radiopharmaceuticals based on the tailored quality control program; and
collecting information produced by the plurality of selected quality control tests.

2. The method of claim 1, wherein uniquely identifying each of the plurality of radiopharmaceuticals further comprises using at least one of a barcode, Radio- frequency identifier (RFID), and customized tag associated with each of the plurality of radiopharmaceuticals.

3. The method of claim 2, wherein the at least one of a barcode, Radio- frequency identifier (RFID), and customized tag is configured to correspond to the plurality of selected quality control tests for each of the radiopharmaceuticals.

4. The method of claim 1, wherein automatically performing the plurality of selected quality control tests further comprises use of contemporaneous scheduling of at least two operations so as to reduce time to completion of the tailored quality control program.

5. The method of claim 1, wherein the tailored quality control program for each of the radiopharmaceuticals is performed in parallel to one another.

6. The method of claim 1, wherein each of the radiopharmaceuticals is configured to be partitioned into a plurality of parts.

7. The method of claim 6, wherein each of the plurality of parts is configured to be directed to a plurality of instruments corresponding to the plurality of selected quality control tests for each of the radiopharmaceuticals.

8. A system for performing automated quality control analysis of a plurality of radiopharmaceuticals, the system comprising:
at least one processor configured to:
uniquely identify each of the plurality of radiopharmaceuticals,
identify and implement a tailored quality control program for each of the radiopharmaceuticals,
automatically perform a plurality of selected quality control tests for each of the radiopharmaceuticals based on the tailored quality control program, and
collect information produced by the plurality of selected quality control tests; and
a memory coupled to the at least processor configured to store the collected information.

9. The system of claim 8, wherein uniquely identify each of the plurality of radiopharmaceuticals further comprises using at least one of a barcode, Radio-frequency identifier (RFID), or customized tag associated with each of the plurality of radiopharmaceuticals.

10. The system of claim 9, wherein the at least one of a barcode, Radio-frequency identifier (RFID), and customized tag is configured to correspond to the plurality of selected quality control tests for each of the radiopharmaceuticals.

11. The system of claim 8, wherein automatically performing the plurality of selected quality control tests further comprises use of contemporaneous scheduling of at least two operations so as to reduce time to completion of the tailored quality control program.

12. The system of claim 8, wherein the tailored quality control program for each of the radiopharmaceuticals is performed in parallel to one another.

13. The system of claim 8, wherein each of the radiopharmaceuticals is configured to be partitioned into a plurality of parts.

14. The system of claim 13, wherein each of the plurality of parts is configured to be directed to a plurality of instruments corresponding to the plurality of selected quality control tests for each of the radiopharmaceuticals.

15. A computer program product comprising a computer usable medium having control logic stored thereon for causing a computer to perform automated quality control analysis of a plurality of radiopharmaceuticals, the control logic comprising:
computer readable program code means for uniquely identifying each of the plurality of radiopharmaceuticals;
computer readable program code means for identifying and implementing a tailored quality control program for each of the radiopharmaceuticals;
computer readable program code means for automatically performing a plurality of selected quality control tests for each of the radiopharmaceuticals based on the tailored quality control program; and
computer readable program code means for collecting information produced by the plurality of selected quality control tests.

16. A system for performing automated quality control analysis of a plurality of radiopharmaceuticals, the system comprising:
modules for uniquely identifying each of the plurality of radiopharmaceuticals;
modules for identifying and implementing a tailored quality control program for each of the radiopharmaceuticals;
modules for automatically performing a plurality of selected quality control tests for each of the radiopharmaceuticals based on the tailored quality control program; and
modules for collecting information produced by the plurality of selected quality control tests.

17. The system of claim 16, wherein the modules for uniquely identifying each of the plurality of radiopharmaceuticals further comprise modules for using at least one of a barcode, Radio-frequency identifier (RFID), and customized tag associated with each of the plurality of radiopharmaceuticals.

18. The system of claim 17, wherein the at least one of a barcode, Radio-frequency identifier (RFID), and customized tag is configured to correspond to the plurality of selected quality control tests for each of the radiopharmaceuticals.

19. The system of claim 16, wherein the modules for automatically performing the plurality of selected quality control tests further comprise modules for contemporaneous scheduling at least two operations so as to reduce time to completion of the tailored quality control program.

20. The system of claim 16, wherein the tailored quality control program for each of the radiopharmaceuticals is performed in parallel to one another.
